(19) United States
(12) Patent Application Publication
(10) Pub. No.: US 2014/0316667 A1
(43) Pub. Date: Oct. 23, 2014

(54) HYDRAULIC CONTROL DEVICE AND HYDRAULIC CONTROL METHOD THEREOF

(71) Applicant: MANDO CORPORATION, Pyeongtaek-si (KR)

(72) Inventor: Won-Suk LEE, Seoul (KR)

(73) Assignee: MANDO CORPORATION, Pyeongtaek-si (KR)

(21) Appl. No.: 14/259,721

(22) Filed: Apr. 23, 2014

(30) Foreign Application Priority Data
Apr. 23, 2013 (KR) 10-2013-0044736

(51) Int. Cl. B60T 8/17; B60T 8/171

(52) U.S. Cl. CPC B60T 8/17; B60T 8/171
USPC 701/70

(57) ABSTRACT

Disclosed are a hydraulic control device and a hydraulic control method thereof. The hydraulic control device includes a hydraulic-valve sensing unit to sense the magnitude of current brake-pressure from a hydraulic valve, a pressure creating-state sensing unit to sense the magnitude of currently created pressure from a pressure creating/providing unit that creates a given level of pressure to provide the hydraulic valve with the created pressure, a first judging unit to judge whether the magnitude of current brake-pressure deviates from a preset target brake pressure range, and/or whether the magnitude of currently created pressure deviates from a preset target pressure creation range, a first identifying unit to enable identification of the first state, and/or identification of the second state, and a controller to receive the magnitude of current brake pressure and the magnitude of currently created pressure and transmit a judgment command to the first judging unit.

### CROSS-REFERENCE TO RELATED APPLICATION

This application claims the benefit of Korean Patent Applications No. 2013-0044736, filed on Apr. 23, 2013 in the Korean Intellectual Property Office, the disclosure of which is incorporated herein by reference.

### BACKGROUND

1. Field

Embodiments of the present invention relate to a hydraulic control device and a hydraulic control method thereof.

2. Description of the Related Art

Generally, conventional brake devices for vehicles are adapted to stop a vehicle at a desired position when a driver activates the brakes.

These conventional vehicular brake devices include a hydraulic circuit in which a hydraulic valve is selectively opened or closed to provide left wheels and right wheels with hydraulic-pressure fed from a hydraulic providing unit via braking operation of a brake operating unit, thereby stopping the wheels at a desired position.

However, in the conventional vehicular brake devices, when hydraulic-pressure is provided to the left wheels and the right wheels via the hydraulic circuit, an abnormal magnitude of current brake pressure may limit maintenance of brake force, and consequently limit braking by an improved brake distance.

In one example, in the conventional vehicular brake devices, when hydraulic pressure is provided to the left wheels and the right wheels via the hydraulic circuit, a high-pressure accumulator sensor may fail to accurately sense the magnitude of current brake pressure due to abnormal operation thereof. In this case, braking is implemented based on the inaccurate magnitude of current brake pressure, which limits maintenance of brake force.

Therefore, research on improved hydraulic control devices and hydraulic control methods thereof, which efficiently improve brake force to enable braking by an improved brake distance and induce a driver to carefully drive and to carefully step on a brake pedal, have been continuously conducted in recent years.

### SUMMARY

It is one aspect of the present invention to provide a hydraulic control device and a hydraulic control method thereof, which may induce a driver to carefully drive and to carefully step on a brake pedal.

It is another aspect of the present invention to provide a hydraulic control device and a hydraulic control method thereof, which may efficiently improve brake force to enable braking by an improved brake distance.

Additional aspects of the invention will be set forth in part in the description which follows and, in part, will be obvious from the description, or may be learned by practice of the invention.

In accordance with one aspect of the invention, a hydraulic control device includes a hydraulic valve sensing unit to sense the magnitude of current brake pressure fed from a hydraulic valve, a pressure creating-state sensing unit to sense the magnitude of currently created pressure fed via a pressure creating/providing unit, the pressure creating/providing unit creating a given level of pressure to provide the hydraulic valve with the created pressure, a first judging unit to implement operation to judge whether the sensed magnitude of current brake pressure is in a first state deviating from a preset target brake pressure range, and/or operation to judge whether the sensed magnitude of currently created pressure is in a second state deviating from a preset target pressure creation range, a first identifying unit to implement operation to enable identification of the first state upon judgment of the first state, and/or operation to enable identification of the second state upon judgment of the second state, and a controller to receive the magnitude of current brake pressure and the magnitude of currently created pressure, and to transmit a judgment command to the first judging unit to allow the first judging unit to judge at least one of the first state and the second state.

The hydraulic control device may further include a brake pressure correction unit to open the hydraulic valve upon judgment of the first state, so as to correct brake hydraulic pressure, fed from a hydraulic-pressure providing unit via braking operation of a brake operating unit, into hydraulic pressure conforming to the target brake pressure range and to provide a left wheel and a right wheel with the corrected brake pressure.

The hydraulic control device may further include a second identifying unit to enable identification of a current brake pressure correcting situation when providing the left wheel and the right wheel with the corrected brake pressure.

The hydraulic control device may further include a pressure creation-correction unit to correct currently created pressure into a given level of pressure conforming to the target pressure creation range upon judgment of the second state and to provide the hydraulic valve with corrected magnitude of created pressure.

The hydraulic control device may further include a third identifying unit to enable identification of a current created pressure correcting situation when providing the hydraulic valve with the corrected magnitude of created pressure.

The hydraulic control device may further include a second judging unit to judge whether the magnitude of current brake pressure per currently created pressure, sensed by the hydraulic-valve sensing unit and the pressure creating-state sensing unit, is in a third state deviating from a preset target brake pressure range per target pressure creation range, and a fourth identifying unit to enable identification of a situation in which the magnitude of current brake pressure per currently created pressure deviates from the preset target brake pressure range per target pressure creation range upon judgment of the third state.

The hydraulic control device may further include a created pressure based brake pressure correction unit to open the hydraulic valve upon judgment of the third state, so as to correct brake hydraulic pressure, fed from a hydraulic-pressure providing unit via braking operation of a brake operating unit, into hydraulic pressure conforming to the target brake pressure range per target pressure creation range and to provide the left wheel and the right wheel with the corrected brake pressure per created pressure.

The hydraulic control device may further include a fifth identifying unit to enable identification of a current created pressure based brake pressure correcting situation when providing the left wheel and the right wheel with the corrected brake pressure per created pressure.

In accordance with another aspect of the present invention, a hydraulic control method includes hydraulic-pressure provision to provide a left wheel and a right wheel with hydraulic pressure, fed from a hydraulic-pressure providing unit via braking operation of a brake operating unit, by selectively opening or closing a hydraulic valve in response to a drive signal of a drive motor, sensing to sense the magnitude of current brake pressure fed from the hydraulic valve and to sense the magnitude of currently created pressure fed via a pressure creating/providing unit, the pressure creating/providing unit creating a given level of pressure to provide the hydraulic valve with the created pressure, first judgment to implement operation to judge whether the sensed magnitude of current brake pressure is in a first state deviating from a preset target brake pressure range, and/or operation to judge whether the sensed magnitude of currently created pressure is in a second state deviating from a preset target pressure creation range, and first identification to implement operation to enable identification of the first state upon judgment of the first state, and/or operation to enable identification of the second state upon judgment of the second state.

The hydraulic control method may further include brake pressure correction to open the hydraulic valve upon judgment of the first state, so as to correct brake hydraulic pressure into hydraulic pressure conforming to the target brake pressure range and to provide the left wheel and the right wheel with the corrected brake pressure.

The hydraulic control method may further include second identification to enable identification of a current brake pressure correcting situation when providing the left wheel and the right wheel with the corrected brake pressure.

The hydraulic control method may further include pressure creation-correction to correct currently created pressure into a given level of pressure conforming to the target pressure creation range upon judgment of the second state and to provide the hydraulic valve with the corrected magnitude of created pressure.

The hydraulic control method may further include third identification to enable identification of a current created pressure correcting situation when providing the hydraulic valve with the corrected magnitude of created pressure.

The hydraulic control method may further include second judgment to judge whether the magnitude of current brake pressure per currently created pressure, sensed by the hydraulic-valve sensing unit and the pressure creating-state sensing unit, is in a third state deviating from a preset target brake pressure range per target pressure creation range, and fourth identification to enable identification of a situation in which the magnitude of current brake pressure per currently created pressure deviates from the preset target brake pressure range per target pressure creation range upon judgment of the third state.

The hydraulic control method may further include created pressure based brake pressure correction to open the hydraulic valve upon judgment of the third state, so as to correct brake hydraulic pressure, fed from the hydraulic-pressure providing unit via braking operation of the brake operating unit, into hydraulic pressure conforming to the target brake pressure range per target pressure creation range and to provide the left wheel and the right wheel with the corrected brake pressure per created pressure.

The hydraulic control method may further include fifth identification to enable identification of a current created pressure based brake pressure correcting situation when providing the left wheel and the right wheel with the corrected brake pressure per created pressure.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a block diagram showing a brake operating unit, a hydraulic-pressure providing unit, a drive motor, left wheels, and right wheels, all of which are connected to a hydraulic control device according to a first embodiment of the present invention;

FIG. 2 is a block diagram showing one example of the hydraulic control device shown in FIG. 1;

FIG. 3 is a system circuit diagram showing exemplary connection between a hydraulic valve, hydraulic-valve sensing unit, pressure creating/providing unit, and pressure creating-state sensing unit included in the hydraulic control device shown in FIG. 2 and the brake operating unit, hydraulic-pressure providing unit, drive motor, left wheels, and right wheels;

FIG. 4 is a flowchart showing a hydraulic control method of the hydraulic control device according to the first embodiment of the present invention;

FIG. 5 is a block diagram showing an exemplary hydraulic control device according to a second embodiment of the present invention;

FIG. 6 is a flowchart showing a hydraulic control method of the hydraulic control device according to the second embodiment of the present invention;

FIG. 7 is a block diagram showing an exemplary hydraulic control device according to a third embodiment of the present invention;

FIG. 8 is a flowchart showing a hydraulic control method of the hydraulic control device according to the third embodiment of the present invention;

FIG. 9 is a block diagram showing one example of a hydraulic control device according to a fourth embodiment of the present invention;

FIG. 10 is a flowchart showing a hydraulic control method of the hydraulic control device according to the fourth embodiment of the present invention;

FIG. 11 is a block diagram showing an exemplary hydraulic control device according to a fifth embodiment of the present invention;

FIG. 12 is a flowchart showing a hydraulic control method of the hydraulic control device according to the fifth embodiment of the present invention;

FIG. 13 is a block diagram showing an exemplary hydraulic control device according to a sixth embodiment of the present invention;

FIG. 14 is a flowchart showing a hydraulic control method of the hydraulic control device according to the sixth embodiment of the present invention;

FIG. 15 is a block diagram showing an exemplary hydraulic control device according to a seventh embodiment of the present invention;

FIG. 16 is a flowchart showing a hydraulic control method of the hydraulic control device according to the seventh embodiment of the present invention;

FIG. 17 is a block diagram showing an exemplary hydraulic control device according to an eighth embodiment of the present invention; and

FIG. 18 is a flowchart showing a hydraulic control method of the hydraulic control device according to the eighth embodiment of the present invention.

### DETAILED DESCRIPTION

Reference will now be made in detail to the embodiments of the present invention, examples of which are illustrated in the accompanying drawings, wherein like reference numerals refer to like elements throughout.

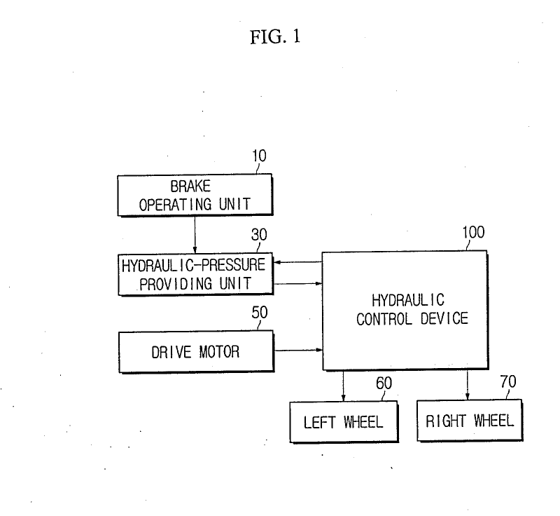

FIG. 1 is a block diagram showing a brake operating unit, a hydraulic-pressure providing unit, a drive motor, left wheels, and right wheels, all of which are connected to a hydraulic control device according to a first embodiment of the present invention.

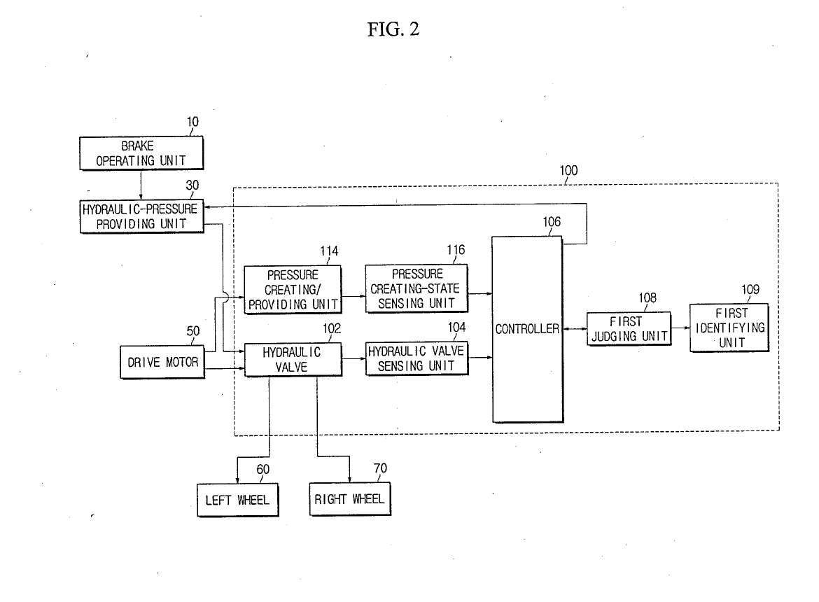

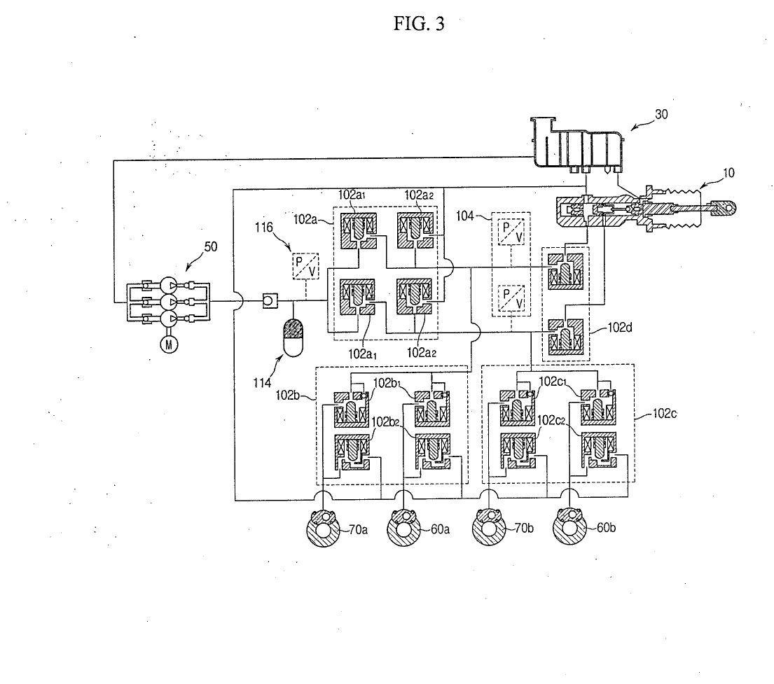

FIG. 2 is a block diagram showing one example of the hydraulic control device shown in FIG. 1, and FIG. 3 is a system circuit diagram showing exemplary connection between a hydraulic valve, a hydraulic-valve sensing unit, a pressure creating/providing unit, and a pressure creating-state sensing unit included in the hydraulic control device shown in FIG. 2 and the brake operating unit, the hydraulic-pressure providing unit, the drive motor, the left wheels, and the right wheels.

Referring to FIGS. 1 to 3, the hydraulic control device, designated by reference numeral 100, according to the first embodiment of the present invention includes a hydraulic valve 102, a hydraulic-valve sensing unit 104, a pressure creating/providing unit 114, a pressure creating-state sensing unit 116, a controller 106, a first judging unit 108, and a first identifying unit 109.

The hydraulic valve 102 is selectively opened or closed in response to a drive signal of a drive motor 50 to provide a left wheel 60 and a right wheel 70 with hydraulic-pressure fed from a hydraulic-pressure providing unit 30 via braking operation of a brake operating unit 10 under control of the controller 106.

Here, as exemplarily shown in FIG. 3, the left wheel 60 may include a rear left wheel 60a and a front left wheel 60b, and the right wheel 70 may include a rear right wheel 70a and a front right wheel 70b.

In this case, as exemplarily shown in FIG. 3, the hydraulic valve 102 may include a first hydraulic valve 102a, a second hydraulic valve 102b, a third hydraulic valve 102c, and a fourth hydraulic valve 102d.

The first hydraulic valve 102a may include inlet valves 102a1 and outlet valves 102a2 to selectively feed the hydraulic-pressure fed from the hydraulic-pressure providing unit 30.

The second hydraulic valve 102b may include normally open (NO) solenoid valves 102b1, which are operated to interrupt hydraulic-pressure fed from the outlet valves 102a2 of the first hydraulic valve 102a located at the upper end thereof upon receiving a control signal from the controller 106 for control of an anti-lock braking system (ABS), and to allow the rear left wheel 60a and the rear right wheel 70a to implement an ABS mode.

On the other hand, the second hydraulic valve 102b may include normally closed (NC) solenoid valves 102b2, which are operated to feed hydraulic-pressure fed from the outlet valves 102a2 of the first hydraulic valve 102a located at the upper end thereof upon receiving a control signal from the controller 106 for control of the ABS, and to allow the rear left wheel 60a and the rear right wheel 70a to be released from the ABS mode.

The third hydraulic valve 102c may include normally open (NO) solenoid valves 102c1, which are operated to interrupt hydraulic-pressure fed from the outlet valves 102a2 of the first hydraulic valve 102a located at the lower end thereof upon receiving a control signal from the controller 106 for control of the ABS, and to allow the front left wheel 60b and the front right wheel 70b to implement the ABS mode.

On the other hand, the third hydraulic valve 102c may include normally closed (NC) solenoid valves 102c2, which are operated to feed hydraulic-pressure fed from the outlet valves 102a2 of the first hydraulic valve 102a located at the lower end thereof upon receiving a control signal from the controller 106 for control of the ABS, and to allow the front left wheel 60b and the front right wheel 70b to be released from the ABS mode.

The fourth hydraulic valve 102d may include fuel cut solenoid valves to interrupt hydraulic-pressure fed from the hydraulic-pressure providing unit 30 via braking operation of the brake operating unit 10.

The hydraulic-valve sensing unit 104 senses the magnitude of current brake pressure fed from the hydraulic valve 102.

In this case, as exemplarily shown in FIG. 3, the hydraulic-valve sensing unit 104 may include a boost chamber pressure sensor.

The pressure creating/providing unit 114 is selectively operated in response to a drive signal of the drive motor 50, and creates a given level of pressure to provide the hydraulic valve 102 with the same.

In this case, as exemplarily shown in FIG. 3, the pressure creating/providing unit 114 may include a high-pressure accumulator.

The pressure creating-state sensing unit 116 senses the magnitude of currently created pressure output from the pressure creating/providing unit 114.

In this case, as exemplarily shown in FIG. 3, the pressure creating-state sensing unit 116 may include a high-pressure accumulator sensor.

The first judging unit 108 implements operation to judge whether the magnitude of current brake pressure, sensed by the hydraulic-valve sensing unit 104, is in a first state deviating from a preset target brake pressure range, and/or operation to judge whether the magnitude of currently created pressure, sensed by the pressure creating-state sensing unit 116, is in a second state deviating from a preset target pressure creation range.

When the first judging unit 108 judges that the magnitude of current brake pressure is in the first state deviating from the target brake pressure range, the first identifying unit 109 implements operation to allow a driver to identify that the magnitude of current brake pressure is in the first state deviating from the target brake pressure range.

In addition, when the first judging unit 108 judges that the magnitude of currently created pressure is in the second state deviating from the target pressure creation range, the first identifying unit 109 implements operation to allow the driver to identify that the magnitude of currently created pressure is in the second state deviating from the target pressure creation range.

In this case, although not shown, the first identifying unit 109 may include at least one of a speaker (not shown) and a light emitting member (not shown), which assist the driver in identifying vehicle information or state, and a Human Machine Interface (HMI) module (not shown) and a Head-Up Display (HUD) module (not shown), which assist the driver in recognizing vehicle information or state via interaction of a user and a machine. Through at least one of audio output by the speaker (not shown), light emission by the light emitting member (not shown), HMI message display by the HMI module (not shown), and HUD message display by the HUD module (not shown), identification of a situation in which the magnitude of current brake pressure deviates from the target brake pressure range and a situation in which the magnitude of currently created pressure deviates from the target pressure creation range may be possible.

The controller 106 receives the magnitude of current brake pressure from the hydraulic-valve sensing unit 104 and the magnitude of currently created pressure from the pressure creating-state sensing unit 116, and transmits a judgment command to the first judging unit 108 to allow the first judging unit 108 to judge at least one of the first state and the second state described above.

Here, although not shown, the controller 106 and the first judging unit 108 may include a conventional Electric Control Unit (ECU) (not shown) that is a main computer for a vehicle to control and judge all operations, or a conventional Micro Control Unit (MCU) (not shown) in which a processor, a memory, and input/output devices are incorporated in a single chip to control and judge all operations, without being limited thereto, and various other control and judging devices to control and judge all operations of a vehicle may be employed.

In this case, although not shown, the controller 106 and the first judging unit 108 may be an integrated ECU or MCU, or may be separate ECUs or MCUs.

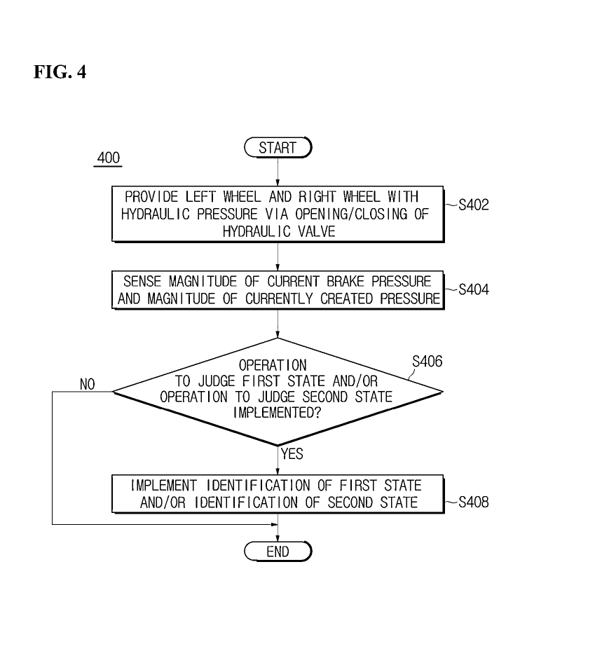

Now, a hydraulic control method for control of hydraulic-pressure using the hydraulic control device 100 according to the first embodiment of the present invention will be described with reference to FIG. 4.

FIG. 4 is a flowchart showing a hydraulic control method of the hydraulic control device according to the first embodiment of the present invention.

Referring to FIG. 4, the hydraulic control method, designated by reference numeral 400, of the hydraulic control device (100 in FIGS. 1 and 2) according to the first embodiment of the present invention includes hydraulic-pressure provision S402, sensing S404, first judgment S406, and first identification S408.

First, in the hydraulic-pressure provision S402, the hydraulic valve 102; 102a, 102b, 102c, 102d is selectively opened or closed in response to a drive signal of the drive motor 50 to provide the left wheel 60; 60a, 60b and the right wheel 70; 70a, 70b with hydraulic-pressure fed from the hydraulic-pressure providing unit 30 by braking operation of the brake operating unit 10.

Thereafter, in the sensing S404, the hydraulic-valve sensing unit 104 senses the magnitude of current brake pressure fed from the hydraulic valve 102; 102a, 102b, 102c, 102d, and the pressure creating-state sensing unit 116 senses the magnitude of currently created pressure fed via the pressure creating/providing unit 114 as the pressure creating/providing unit 114 creates a given level of pressure and provides the hydraulic valve 102; 102a, 102b, 102c, 102d with the same.

Thereafter, in the first judgment S406, the first judging unit 108 judges, under control of the controller 106, whether the magnitude of current brake pressure, sensed by the hydraulic-valve sensing unit 104, is in a first state deviating from a target brake pressure range set in the first judging unit 108.

In addition, in the first judgment S406, the first judging unit 108 judges, under control of the controller 106, whether the magnitude of currently created pressure, sensed by the pressure creating-state sensing unit 116, is in a second state deviating from a target pressure creation range set in the first judging unit 108.

Finally, in the first identification S408, when the first judging unit 108 judges that the magnitude of current brake pressure is in the first state deviating from the target brake pressure range, the first identifying unit 109 assists the driver in identifying that the magnitude of current brake pressure is in the first state deviating from the target brake pressure range.

In addition, in the first identification S408, when the first judging unit 108 judges that the magnitude of currently created pressure is in the second state deviating from the target pressure creation range, the first identifying unit 109 assists the driver in identifying that the magnitude of currently created pressure is in the second state deviating from the target pressure creation range.

As described above, the hydraulic control device 100 and the hydraulic control method 400 thereof according to the first embodiment of the present invention include the hydraulic valve 102, the hydraulic-valve sensing unit 104, the pressure creating/providing unit 114, the pressure creating-state sensing unit 116, the controller 106, the first judging unit 108, and the first identifying unit 109, and implement the hydraulic-pressure provision S402, the sensing S404, the first judgment S406, and the first identification S408.

Accordingly, when the magnitude of current brake pressure deviates from the target brake pressure range, the hydraulic control device 100 and the hydraulic control method 400 thereof according to the first embodiment of the present invention may enable identification of a situation in which the magnitude of current brake pressure deviates from the target brake pressure range.

In this way, the hydraulic control device 100 and the hydraulic control method 400 thereof according to the first embodiment of the present invention may assist the driver in recognizing the situation in which the magnitude of current brake pressure deviates from the target brake pressure range, which may induce the driver to carefully drive and to carefully step on a brake pedal.

In addition, when the magnitude of currently created pressure deviates from the target pressure creation range, the hydraulic control device 100 and the hydraulic control method 400 thereof according to the first embodiment of the present invention may enable identification of a situation in which the magnitude of currently created pressure deviates from the target pressure creation range.

In this way, the hydraulic control device 100 and the hydraulic control method 400 thereof according to the first embodiment of the present invention may assist the driver in recognizing the situation in which the magnitude of currently created pressure deviates from the target pressure creation range, which may induce the driver to carefully drive and to carefully step on the brake pedal.

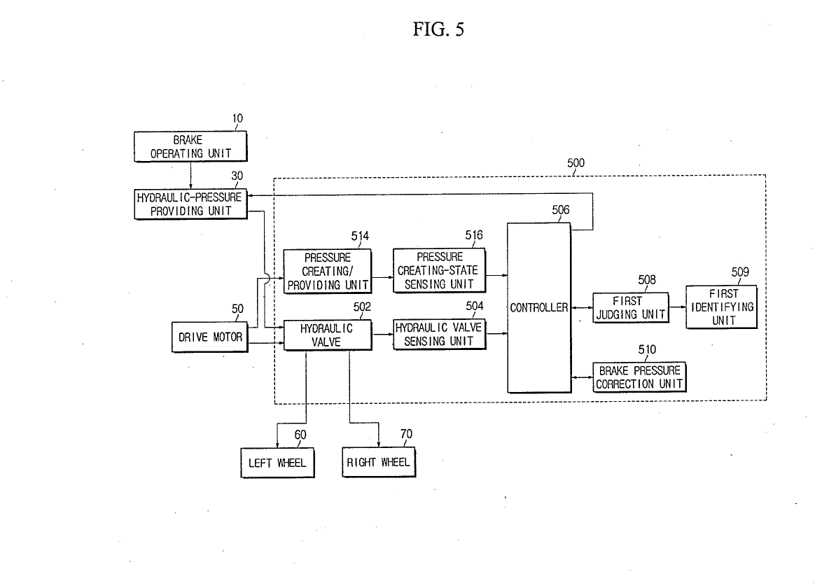

FIG. 5 is a block diagram showing an exemplary hydraulic control device according to a second embodiment of the present invention.

Referring to FIG. 5, the hydraulic control device, designated by reference numeral 500, according to the second embodiment of the present invention includes a hydraulic valve 502, a hydraulic-valve sensing unit 504, a pressure creating/providing unit 514, a pressure creating-state sensing unit 516, a controller 506, a first judging unit 508, and a first identifying unit 509, in the same manner as the hydraulic control device (100 in FIG. 2) according to the first embodiment.

Functions of and organic connection relationships between the hydraulic valve 502, the hydraulic-valve sensing unit 504, the pressure creating/providing unit 514, the pressure creating-state sensing unit 516, the controller 506, the first judging unit 508, and the first identifying unit 509 of the hydraulic control device 500 according to the second embodiment of the present invention are equal to functions of and organic connection relationships between the hydraulic valve (102 in FIG. 2), the hydraulic-valve sensing unit (104 in FIG. 2), the pressure creating/providing unit (114 in FIG. 2), the pressure creating-state sensing unit (116 in FIG. 2), the controller (106 in FIG. 2), the first judging unit (108 in FIG. 2), and the first identifying unit (109 in FIG. 2) of the hydraulic control device (100 in FIG. 2) according to the first embodiment of the present invention, and thus additional descriptions of the respective components will be omitted below.

Here, the hydraulic control device 500 according to the second embodiment of the present invention further includes a brake pressure correction unit 510.

More specifically, when the first judging unit 508 judges that the magnitude of current brake pressure is in a first state deviating from a target brake pressure range, the brake pressure correction unit 510 opens the hydraulic valve 502 to correct brake pressure, i.e. hydraulic-pressure, fed from the hydraulic-pressure providing unit 30 via braking operation of the brake operating unit 10 under control of the controller 506, into hydraulic-pressure conforming to the target brake pressure range under control of the controller 506, and to provide the left wheel 60 and the right wheel 70 with the corrected brake pressure.

Here, although not shown, the controller 506, the first judging unit 508, and the brake pressure correction unit 510 may include a conventional ECU (not shown) that is a main computer for a vehicle to control and judge all operations and to correct brake pressure, or a conventional MCU (not shown) in which a processor, a memory, and input/output devices are incorporated in a single chip to control and judge all operations and to correct brake pressure, without being limited thereto, and various other devices to control and judge all operations of a vehicle and to correct brake pressure may be employed.

In this case, although not shown, the controller 506, the first judging unit 508, and the brake pressure correction unit 510 may be an integrated ECU or MCU, or may be separate ECUs or MCUs.

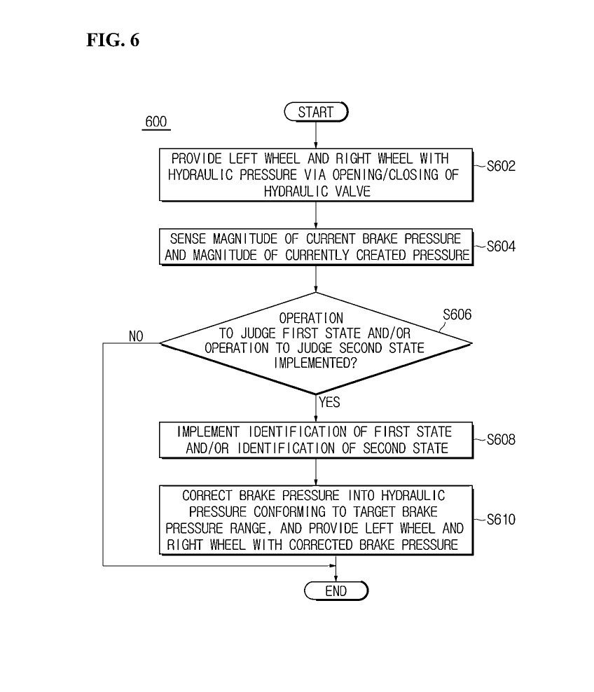

Now, a hydraulic control method for control of hydraulic-pressure using the hydraulic control device 500 according to the second embodiment of the present invention will be described with reference to FIG. 6.

FIG. 6 is a flowchart showing a hydraulic control method of the hydraulic control device according to the second embodiment of the present invention.

Referring to FIG. 6, the hydraulic control method, designated by reference numeral 600, of the hydraulic control device (500 in FIG. 5) according to the second embodiment of the present invention includes hydraulic-pressure provision S602, sensing S604, first judgment S606, and first identification S608, in the same manner as the hydraulic control method (400 in FIG. 4) of the hydraulic control device (100 in FIG. 2) according to the first embodiment.

Functions of and organic connection relationships between the hydraulic-pressure provision S602, the sensing S604, the first judgment S606, and the first identification S608 of the hydraulic control method 600 of the hydraulic control device (500 in FIG. 5) according to the second embodiment of the present invention are equal to functions of and organic connection relationships between the hydraulic-pressure provision (S402 in FIG. 4), the sensing (S404 in FIG. 4), the first judgment (S406 in FIG. 4), and the first identification (S408 in FIG. 4) of the hydraulic control method (400 in FIG. 4) of the hydraulic control device (100 in FIG. 2) according to the first embodiment of the present invention, and thus additional descriptions of the respective operations will be omitted below.

Here, the hydraulic control method 600 of the hydraulic control device 500 according to the second embodiment of the present invention further includes brake pressure correction S610.

In one example, the hydraulic control method 600 of the hydraulic control device 500 according to the second embodiment of the present invention may further include the brake pressure correction S610 after the first identification S608.

In another example, although not shown, a hydraulic control method (not shown) of the hydraulic control device 500 according to the second embodiment of the present invention may further include brake pressure correction (not shown) synchronized with first identification (not shown).

More specifically, when the first judging unit 508 judges that the magnitude of current brake pressure is in the first state deviating from the target brake pressure range, in the brake pressure correction S610, the brake pressure correction unit 510 opens the hydraulic valve 502 to correct brake pressure, i.e. hydraulic-pressure, fed from the hydraulic-pressure providing unit 30 via braking operation of the brake operating unit 10 under control of the controller 506, into hydraulic-pressure conforming to the target brake pressure range under control of the controller 506, and to provide the left wheel 60 and the right wheel 70 with the corrected brake pressure.

As described above, the hydraulic control device 500 and the hydraulic control method 600 thereof according to the second embodiment of the present invention include the hydraulic valve 502, the hydraulic-valve sensing unit 504, the pressure creating/providing unit 514, the pressure creating-state sensing unit 516, the controller 506, the first judging unit 508, the first identifying unit 509, and the brake pressure correction unit 510, and implement the hydraulic-pressure provision S602, the sensing S604, the first judgment S606, the first identification S608, and the brake pressure correction S610.

Accordingly, when the magnitude of current brake pressure deviates from the target brake pressure range, the hydraulic control device 500 and the hydraulic control method 600 thereof according to the second embodiment of the present invention may provide identification of a situation in which the magnitude of current brake pressure deviates from the target brake pressure range.

In this way, the hydraulic control device 500 and the hydraulic control method 600 thereof according to the second embodiment of the present invention may assist the driver in recognizing the situation in which the magnitude of current brake pressure deviates from the target brake pressure range, which may induce the driver to carefully drive and to carefully step on the brake pedal.

In addition, when the magnitude of currently created pressure deviates from the target pressure creation range, the hydraulic control device 500 and the hydraulic control method 600 thereof according to the second embodiment of the present invention may enable identification of a situation in which the magnitude of currently created pressure deviates from the target pressure creation range.

In this way, the hydraulic control device 500 and the hydraulic control method 600 thereof according to the second embodiment of the present invention may assist the driver in recognizing the situation in which the magnitude of currently created pressure deviates from the target pressure creation range, which may induce the driver to carefully drive and to carefully step on the brake pedal.

Moreover, when the magnitude of current brake pressure deviates from the target brake pressure range, the hydraulic control device 500 and the hydraulic control method 600 thereof according to the second embodiment of the present invention may correct current brake pressure into hydraulic-pressure conforming to the target brake pressure range, and provide the left wheel 60 and the right wheel 70 with the corrected brake pressure.

In this way, the hydraulic control device 500 and the hydraulic control method 600 thereof according to the second embodiment of the present invention may provide the left wheel 60 and the right wheel 70 with the corrected brake pressure when the driver steps on the brake pedal, thereby efficiently enhancing brake force and enabling braking by an improved brake distance.

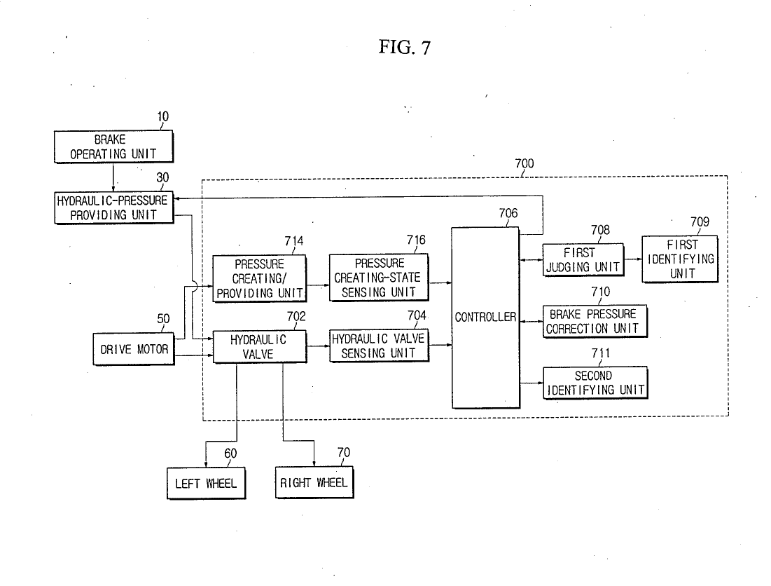

FIG. 7 is a block diagram showing an exemplary hydraulic control device according to a third embodiment of the present invention.

Referring to FIG. 7, the hydraulic control device, designated by reference numeral 700, according to the third embodiment of the present invention includes a hydraulic valve 702, a hydraulic-valve sensing unit 704, a pressure creating/providing unit 714, a pressure creating-state sensing unit 716, a controller 706, a first judging unit 708, a first identifying unit 709, and a brake pressure correction unit 710, in the same manner as the hydraulic control device (500 in FIG. 5) according to the second embodiment.

Functions of and organic connection relationships between the hydraulic valve 702, the hydraulic-valve sensing unit 704, the pressure creating/providing unit 714, the pressure creating-state sensing unit 716, the controller 706, the first judging unit 708, the first identifying unit 709, and the brake pressure correction unit 710 of the hydraulic control device 700 according to the third embodiment of the present invention are equal to functions of and organic connection relationships between the hydraulic valve (502 in FIG. 5), the hydraulic-valve sensing unit (504 in FIG. 5), the pressure creating/providing unit (514 in FIG. 5), the pressure creating-state sensing unit (516 in FIG. 5), the controller (506 in FIG. 5), the first judging unit (508 in FIG. 5), the first identifying unit (509 in FIG. 5), and the brake pressure correction unit (510 in FIG. 5) of the hydraulic control device (500 in FIG. 5) according to the second illustrated embodiment, and thus additional descriptions of the respective components will be omitted below.

Here, the hydraulic control device 700 according to the third embodiment of the present invention further includes a second identifying unit 711.

More specifically, the second identifying unit 711 assists the driver in identifying a current brake pressure correcting situation under control of the controller 706 when providing the left wheel 60 and the right wheel 70 with brake pressure corrected by the brake pressure correction unit 710.

In this case, although not shown, the second identifying unit 711 may include at least one of a speaker (not shown) and a light emitting member (not shown), which assist the driver in identifying vehicle information or state, and an HMI module (not shown) and an HUD module (not shown), which assist the driver in recognizing vehicle information or state via interaction of a user and a machine. Through at least one of audio output by the speaker (not shown), light emission by the light emitting member (not shown), HMI message display by the HMI module (not shown), and HUD message display by the HUD module (not shown), identification of a current brake pressure correcting situation may be possible.

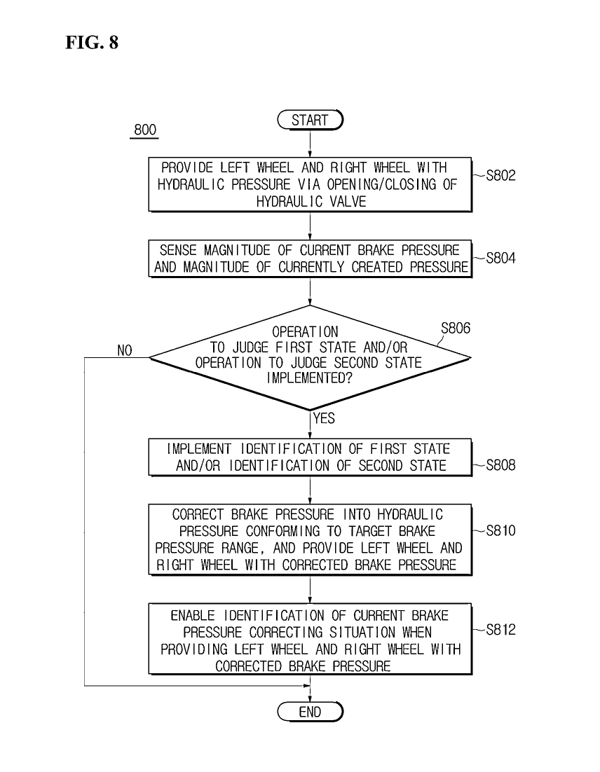

Now, a hydraulic control method for control of hydraulic-pressure using the hydraulic control device 700 according to the third embodiment of the present invention will be described with reference to FIG. 8.

FIG. 8 is a flowchart showing a hydraulic control method of the hydraulic control device according to the third embodiment of the present invention.

Referring to FIG. 8, the hydraulic control method, designated by reference numeral 800, of the hydraulic control device (700 in FIG. 7) according to the third embodiment of the present invention includes hydraulic-pressure provision S802, sensing S804, first judgment S806, first identification S808, and brake pressure correction S810, in the same manner as the hydraulic control method (600 in FIG. 6) of the hydraulic control device (500 in FIG. 5) according to the second embodiment.

Functions of and organic connection relationships between the hydraulic-pressure provision S802, the sensing S804, the first judgment S806, the first identification S808, and the brake pressure correction S810 of the hydraulic control method 800 of the hydraulic control device (700 in FIG. 7) according to the third embodiment of the present invention are equal to functions of and organic connection relationships between the hydraulic-pressure provision (S602 in FIG. 6), the sensing (S604 in FIG. 6), the first judgment (S606 in FIG. 6), the first identification (S608 in FIG. 6), and the brake pressure correction (S610 in FIG. 6) of the hydraulic control method (600 in FIG. 6) of the hydraulic control device (500 in FIG. 5) according to the second embodiment, and thus additional descriptions of the respective operations will be omitted below.

Here, the hydraulic control method 800 of the hydraulic control device 700 according to the third embodiment of the present invention further includes second identification S812.

In one example, the hydraulic control method 800 of the hydraulic control device 700 according to the third embodiment of the present invention may further include second identification S812 after the brake pressure correction S810.

In another example, although not shown, a hydraulic control method (not shown) of the hydraulic control device 700 according to the third embodiment of the present invention may further include second identification (not shown) synchronized with brake pressure correction (not shown).

More specifically, in the second identification S812, when the brake pressure correction unit 710 provides the left wheel 60 and the right wheel 70 with the corrected brake pressure, the second identifying unit 711 assists the driver in identifying a current brake pressure correcting situation under control of the controller 706.

As described above, the hydraulic control device 700 and the hydraulic control method 800 thereof according to the third embodiment of the present invention include the hydraulic valve 702, the hydraulic-valve sensing unit 704, the pressure creating/providing unit 714, the pressure creating-state sensing unit 716, the controller 706, the first judging unit 708, the first identifying unit 709, the brake pressure correction unit 710, and the second identifying unit 711, and implement the hydraulic-pressure provision S802, the sensing S804, the first judgment S806, the first identification S808, the brake pressure correction S810, and the second identification S812.

Accordingly, when the magnitude of current brake pressure deviates from the target brake pressure range, the hydraulic control device 700 and the hydraulic control method 800 thereof according to the third embodiment of the present invention may enable identification of a situation in which the magnitude of current brake pressure deviates from the target brake pressure range.

In this way, the hydraulic control device 700 and the hydraulic control method 800 thereof according to the third embodiment of the present invention may assist the driver in recognizing the situation in which the magnitude of current brake pressure deviates from the target brake pressure range, which may induce the driver to carefully drive and to carefully step on the brake pedal.

In addition, when the magnitude of currently created pressure deviates from the target pressure creation range, the hydraulic control device 700 and the hydraulic control method 800 thereof according to the third embodiment of the present invention may enable identification of a situation in which the magnitude of currently created pressure deviates from the target pressure creation range.

In this way, the hydraulic control device 700 and the hydraulic control method 800 thereof according to the third illustrated embodiment of the present invention may assist the driver in recognizing the situation in which the magnitude of currently created pressure deviates from the target pressure creation range, which may induce the driver to carefully drive and to carefully step on the brake pedal.

In addition, when the magnitude of current brake pressure deviates from the target brake pressure range, the hydraulic control device 700 and the hydraulic control method 800 thereof according to the third embodiment of the present invention may correct current brake pressure into hydraulic-pressure conforming to the target brake pressure range, and provide the left wheel 60 and the right wheel 70 with the corrected brake pressure.

In this way, the hydraulic control device 700 and the hydraulic control method 800 thereof according to the third embodiment of the present invention may provide the left wheel 60 and the right wheel 70 with the corrected brake pressure when the driver steps on the brake pedal, thereby efficiently enhancing brake force and enabling braking by an improved brake distance.

In addition, when the magnitude of current brake pressure deviates from the target brake pressure range, the hydraulic control device 700 and the hydraulic control method 800 thereof according to the third embodiment of the present invention may enable identification of a current brake pressure correcting situation when correcting current brake pressure into hydraulic-pressure conforming to the target brake pressure range and providing the left wheel 60 and the right wheel 70 with the corrected brake pressure.

In this way, the hydraulic control device 700 and the hydraulic control method 800 thereof according to the third embodiment of the present invention may assist the driver in recognizing the current brake pressure correcting situation, which may induce the driver to carefully drive and to carefully step on the brake pedal.

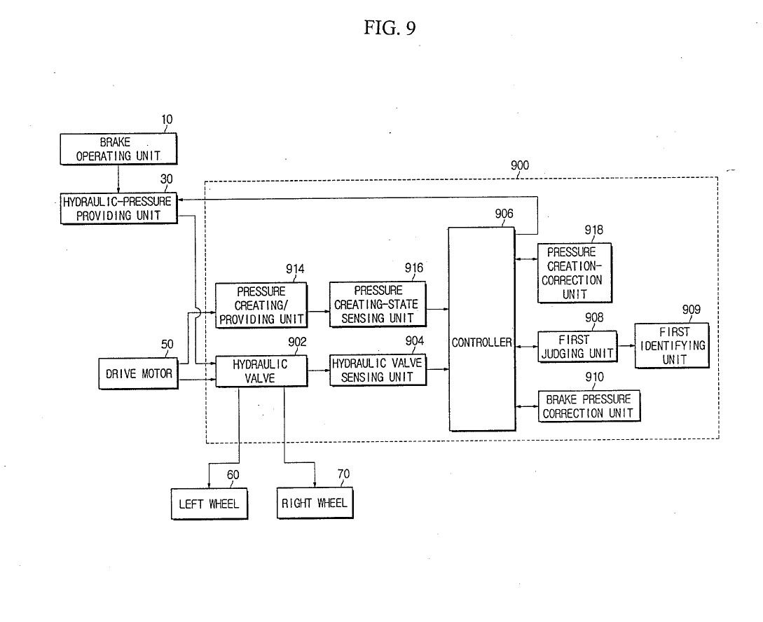

FIG. 9 is a block diagram showing an exemplary hydraulic control device according to a fourth embodiment of the present invention.

Referring to FIG. 9, the hydraulic control device, designated by reference numeral 900, according to the fourth embodiment of the present invention includes a hydraulic valve 902, a hydraulic-valve sensing unit 904, a pressure creating/providing unit 914, a pressure creating-state sensing unit 916, a controller 906, a first judging unit 908, and a first identifying unit 909, in the same manner as the hydraulic control device (100 in FIG. 2) according to the first embodiment.

Functions of and organic connection relationships between the hydraulic valve 902, the hydraulic-valve sensing unit 904, the pressure creating/providing unit 914, the pressure creating-state sensing unit 916, the controller 906, the first judging unit 908, and the first identifying unit 909 of the hydraulic control device 900 according to the fourth embodiment of the present invention are equal to functions of and organic connection relationships between the hydraulic valve (102 in FIG. 2), the hydraulic-valve sensing unit (104 in FIG. 2), the pressure creating/providing unit (114 in FIG. 2), the pressure creating-state sensing unit (116 in FIG. 2), the controller (106 in FIG. 2), the first judging unit (108 in FIG. 2), and the first identifying unit (109 in FIG. 2) of the hydraulic control device (100 in FIG. 2) according to the first embodiment, and thus additional descriptions of the respective components will be omitted below.

Here, the hydraulic control device 900 according to the fourth embodiment of the present invention further includes a pressure creation-correction unit 918.

More specifically, when the first judging unit 908 judges that the magnitude of currently created pressure is in the second state deviating from the target pressure creation range, the pressure creation-correction unit 918 corrects currently created pressure into a given level of pressure conforming to the target pressure creation range under control of the controller 906, and provide the hydraulic valve 902 with the corrected magnitude of created pressure.

In addition, the hydraulic control device 900 according to the fourth embodiment of the present invention may further include a brake pressure correction unit 910.

More specifically, when the first judging unit 908 judges that the magnitude of current brake pressure is in the first state deviating from the target brake pressure range, the brake pressure correction unit 910 opens the hydraulic valve 902 to correct brake pressure, i.e. hydraulic-pressure, fed from the hydraulic-pressure providing unit 30 via braking operation of the brake operating unit 10 under control of the controller 906, into hydraulic-pressure conforming to the target brake pressure range under control of the controller 906, and to provide the left wheel 60 and the right wheel 70 with the corrected brake pressure.

Here, although not shown, the controller 906, the first judging unit 908, the pressure creation-correction unit 918, and the brake pressure correction unit 910 may include a conventional ECU (not shown) that is a main computer for a vehicle to control and judge all operations and to correct created pressure and brake pressure, or a conventional MCU (not shown) in which a processor, a memory, and input/output devices are incorporated in a single chip to control and judge all operations and to correct created pressure and brake pressure, without being limited thereto, and various other devices to control and judge all operations of a vehicle and to correct created pressure and brake pressure may be employed.

In this case, the controller 906, the first judging unit 908, the pressure creation-correction unit 918, and the brake pressure correction unit 910 may be an integrated ECU or MCU, or may be separate ECUs or MCUs.

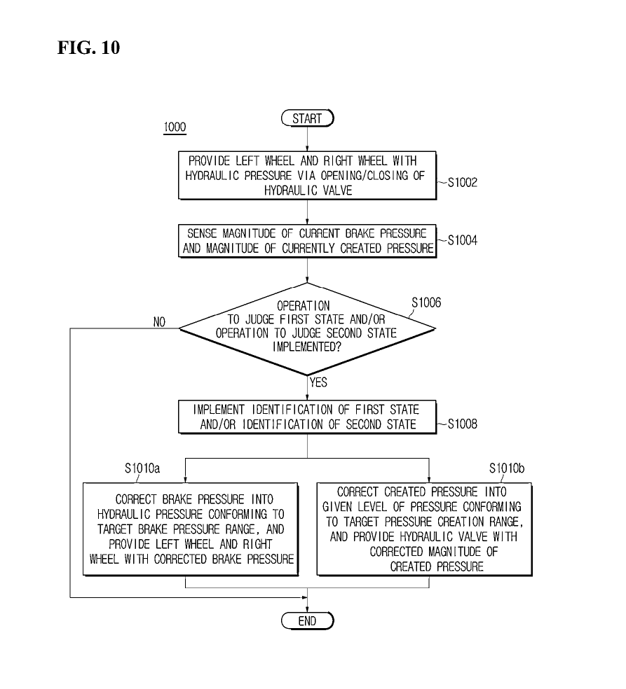

Now, a hydraulic control method for control of hydraulic-pressure using the hydraulic control device 900 according to the fourth embodiment of the present invention will be described with reference to FIG. 10.

FIG. 10 is a flowchart showing a hydraulic control method of the hydraulic control device according to the fourth embodiment of the present invention.

Referring to FIG. 10, the hydraulic control method, designated by reference numeral 1000, of the hydraulic control device (900 in FIG. 9) according to the fourth embodiment of the present invention includes hydraulic-pressure provision S1002, sensing S1004, first judgment S1006, and first identification S1008, in the same manner as the hydraulic control method (400 in FIG. 4) of the hydraulic control device (100 in FIG. 2) according to the first embodiment.

Functions of and organic connection relationships between the hydraulic-pressure provision S1002, the sensing S1004, the first judgment S1006, and the first identification S1008 of the hydraulic control method 1000 of the hydraulic control device (900 in FIG. 9) according to the fourth embodiment of the present invention are equal to functions of and organic connection relationships between the hydraulic-pressure provision (S402 in FIG. 4), the sensing (S404 in FIG. 4), the first judgment (S406 in FIG. 4), and the first identification (S408 in FIG. 4) of the hydraulic control method (400 in FIG. 4) of the hydraulic control device (100 in FIG. 2) according to the first embodiment of the present invention, and thus additional descriptions of the respective operations will be omitted below.

Here, the hydraulic control method 1000 of the hydraulic control device 900 according to the fourth embodiment of the present invention further includes pressure creation-correction S1010b.

In one example, the hydraulic control method 1000 of the hydraulic control device 900 according to the fourth embodiment of the present invention may further include pressure creation-correction S1010b after the first identification S1008.

In another example, although not shown, a hydraulic control method (not shown) of the hydraulic control device 900 according to the fourth embodiment of the present invention may further include pressure creation-correction (not shown) synchronized with first identification (not shown).

More specifically, when the first judging unit 908 judges that the magnitude of currently created pressure is in the second state deviating from the target pressure creation range, in pressure creation-correction S1010b, the pressure creation-correction unit 918 corrects created pressure into a given level of pressure conforming to the target pressure creation range under control of the controller 906, and provides the hydraulic valve 902 with the corrected magnitude of created pressure.

In addition, the hydraulic control method 1000 of the hydraulic control device 900 according to the fourth embodiment of the present invention may further include brake pressure correction S1010a.

In one example, the hydraulic control method 1000 of the hydraulic control device 900 according to the fourth embodiment of the present invention may further include brake pressure correction S1010a after the first identification S1008.

In another example, although not shown, a hydraulic control method (not shown) of the hydraulic control device 900 according to the fourth embodiment of the present invention may further include brake pressure-correction (not shown) synchronized with first identification (not shown).

More specifically, when the first judging unit 908 judges that the magnitude of current brake pressure is in the first state deviating from the target brake pressure range, in the brake pressure correction S1010a, the brake pressure correction unit 910 opens the hydraulic valve 902 to correct brake pressure, i.e. hydraulic-pressure, fed from the hydraulic-pressure providing unit 30 via braking operation of the brake operating unit 10 under control of the controller 906, into hydraulic-pressure conforming to the target brake pressure range under control of the controller 906, and to provide the left wheel 60 and the right wheel 70 with the corrected brake pressure.

As described above, the hydraulic control device 900 and the hydraulic control method 1000 thereof according to the fourth embodiment of the present invention include the hydraulic valve 902, the hydraulic-valve sensing unit 904, the pressure creating/providing unit 914, the pressure creating-state sensing unit 916, the controller 906, the first judging unit 908, the first identifying unit 909, the brake pressure correction unit 910, and the pressure creation-correction unit 918, and implement the hydraulic-pressure provision S1002, the sensing S1004, the first judgment S1006, the first identification S1008, the brake pressure correction S1010a, and the pressure creation-correction S1010b.

Accordingly, when the magnitude of current brake pressure deviates from the target brake pressure range, the hydraulic control device 900 and the hydraulic control method 1000 thereof according to the fourth embodiment of the present invention may enable identification of a situation in which the magnitude of current brake pressure deviates from the target brake pressure range.

In this way, the hydraulic control device 900 and the hydraulic control method 1000 thereof according to the fourth embodiment of the present invention may assist the driver in recognizing the situation in which the magnitude of current brake pressure deviates from the target brake pressure range, which may induce the driver to carefully drive and to carefully step on the brake pedal.

In addition, when the magnitude of currently created pressure deviates from the target pressure creation range, the hydraulic control device 900 and the hydraulic control method 1000 thereof according to the fourth embodiment of the present invention may enable identification of a situation in which the magnitude of currently created pressure deviates from the target pressure creation range.

In this way, the hydraulic control device 900 and the hydraulic control method 1000 thereof according to the fourth embodiment of the present invention may assist the driver in recognizing the situation in which the magnitude of currently created pressure deviates from the target pressure creation range, which may induce the driver to carefully drive and to carefully step on the brake pedal.

In addition, when the magnitude of current brake pressure deviates from the target brake pressure range, the hydraulic control device 900 and the hydraulic control method 1000 thereof according to the fourth embodiment of the present invention may correct current brake pressure into hydraulic-pressure conforming to the target brake pressure range, and provide the left wheel 60 and the right wheel 70 with the corrected brake pressure.

In this way, the hydraulic control device 900 and the hydraulic control method 1000 thereof according to the fourth embodiment of the present invention may provide the left wheel 60 and the right wheel 70 with the corrected brake pressure when the driver steps on the brake pedal, thereby efficiently enhancing brake force and enabling braking by an improved brake distance.

Moreover, when the magnitude of currently created pressure deviates from the target pressure creation range, the hydraulic control device 900 and the hydraulic control method 1000 thereof according to the fourth embodiment of the present invention may correct current brake pressure into a given level of pressure conforming to the target brake pressure range, and provide the hydraulic valve 102 with the corrected magnitude of created pressure.

In this way, the hydraulic control device 900 and the hydraulic control method 1000 thereof according to the fourth embodiment of the present invention may rapidly provide the left wheel 60 and the right wheel 70 with the corrected brake pressure when the driver steps on the brake pedal, thereby efficiently enhancing brake force and enabling braking by an improved brake distance.

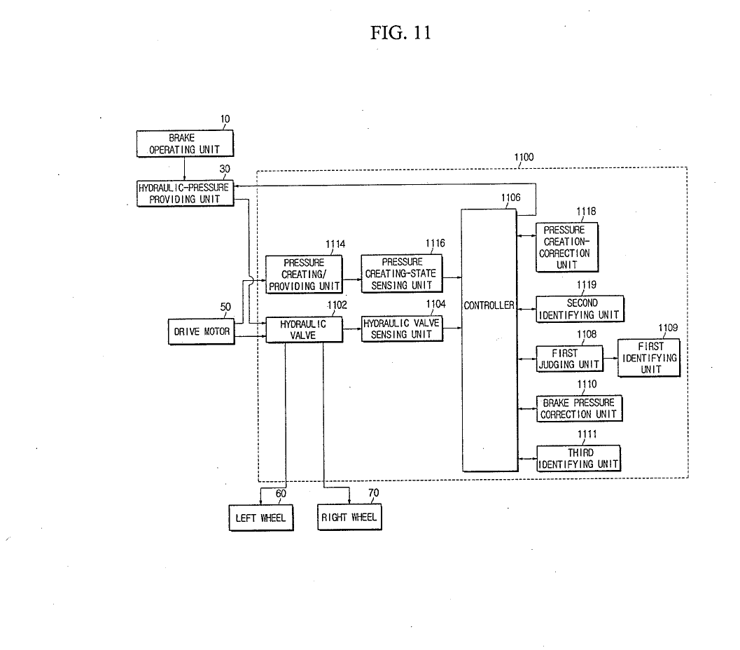

FIG. 11 is a block diagram showing an exemplary hydraulic control device according to a fifth embodiment of the present invention.

Referring to FIG. 11, the hydraulic control device, designated by reference numeral 1100, according to the fifth embodiment of the present invention includes a hydraulic valve 1102, a hydraulic-valve sensing unit 1104, a pressure creating/providing unit 1114, a pressure creating-state sensing unit 1116, a controller 1106, a first judging unit 1108, a first identifying unit 1109, a brake pressure correction unit 1110, and a pressure creation-correction unit 1118, in the same manner as the hydraulic control device (900 in FIG. 9) according to the fourth embodiment.

Functions of and organic connection relationships between the hydraulic valve 1102, the hydraulic-valve sensing unit 1104, the pressure creating/providing unit 1114, the pressure creating-state sensing unit 1116, the controller 1106, the first judging unit 1108, the first identifying unit 1109, the brake pressure correction unit 1110, and the pressure creation-correction unit 1118 of the hydraulic control device 1100 according to the fifth embodiment of the present invention are equal to functions of and organic connection relationships between the hydraulic valve (902 in FIG. 9), the hydraulic-valve sensing unit (904 in FIG. 9), the pressure creating/providing unit (914 in FIG. 9), the pressure creating-state sensing unit (916 in FIG. 9), the controller (906 in FIG. 9), the first judging unit (908 in FIG. 9), the first identifying unit (909 in FIG. 9), the brake pressure correction unit (910 in FIG. 9), and the pressure creation-correction unit (918 in FIG. 9) of the hydraulic control device (900 in FIG. 9) according to the fourth embodiment of the present invention, and thus additional descriptions of the respective components will be omitted below.

Here, the hydraulic control device 1100 according to the fifth embodiment of the present invention further includes a third identifying unit 1111.

More specifically, the third identifying unit 1111 assists the driver in identifying a current created pressure correcting situation under control of the controller 1106 when the pressure creation-correction unit 1118 provides the hydraulic valve 1102 with the corrected magnitude of created pressure.

In this case, although not shown, the third identifying unit 1111 may include at least one of a speaker (not shown) and a light emitting member (not shown), which assist the driver in identifying vehicle information or state, and an HMI module (not shown) and an HUD module (not shown), which assist the driver in recognizing vehicle information or state via interaction of a user and a machine. Through at least one of audio output by the speaker (not shown), light emission by the light emitting member (not shown), HMI message display by the HMI module (not shown), and HUD message display by the HUD module (not shown), identification of a current created pressure correcting situation may be possible.

The hydraulic control device 1100 according to the fifth embodiment of the present invention may further include a second identifying unit 1119.

More specifically, the second identifying unit 1119 may identify a current brake pressure correcting situation under control of the controller 1106 when the brake pressure correction unit 1110 provides the left wheel 60 and the right wheel 70 with the corrected brake pressure.

In this case, although not shown, the second identifying unit 1119 may include at least one of a speaker (not shown) and a light emitting member (not shown), which assist the driver in identifying vehicle information or state, and an HMI module (not shown) and an HUD module (not shown), which assist the driver in recognizing vehicle information or state via interaction of a user and a machine. Through at least one of audio output by the speaker (not shown), light emission by the light emitting member (not shown), HMI message display by the HMI module (not shown), and HUD message display by the HUD module (not shown), identification of a current brake pressure correcting situation may be possible.

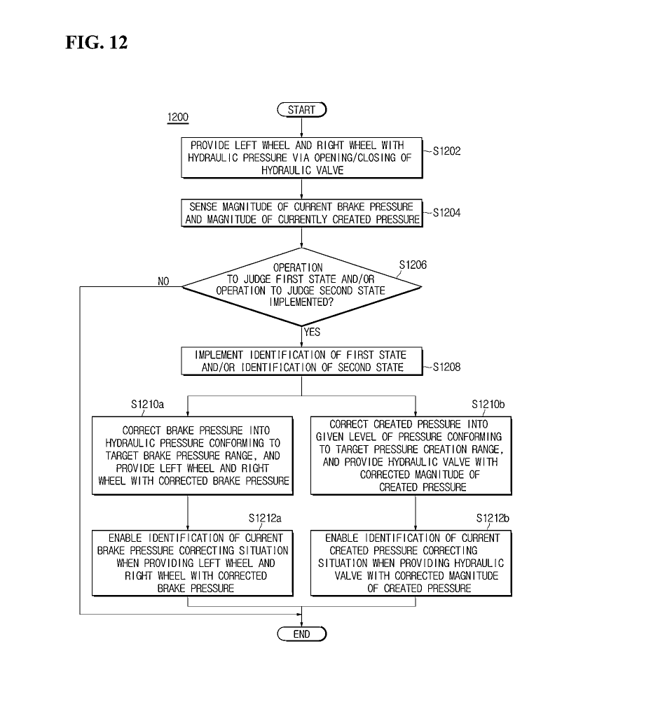

Now, a hydraulic control method for control of hydraulic-pressure using the hydraulic control device 1100 according to the fifth embodiment of the present invention will be described with reference to FIG. 12.

FIG. 12 is a flowchart showing a hydraulic control method of the hydraulic control device according to the fifth embodiment of the present invention.

Referring to FIG. 12, the hydraulic control method, designated by reference numeral 1200, of the hydraulic control device (1100 in FIG. 11) according to the fifth embodiment of the present invention includes hydraulic-pressure provision S1202, sensing S1204, first judgment S1206, first identification S1208, brake pressure correction 1210a, and brake creation-correction 1210b, in the same manner as the hydraulic control method (1000 in FIG. 10) of the hydraulic control device (900 in FIG. 9) according to the fourth embodiment.

Functions of and organic connection relationships between the hydraulic-pressure provision S1202, the sensing S1204, the first judgment S1206, the first identification S1208, the brake pressure correction S1210a, and the pressure creation-correction 1210b of the hydraulic control method 1200 of the hydraulic control device (1100 in FIG. 11) according to the fifth embodiment of the present invention are equal to functions of and organic connection relationships between the hydraulic-pressure provision (S1002 in FIG. 10), the sensing (S1004 in FIG. 10), the first judgment (S1006 in FIG. 10), the first identification (S1008 in FIG. 10), the brake pressure correction (S1010a in FIG. 10), and the pressure creation-correction (S1010b in FIG. 10) of the hydraulic control method (1000 in FIG. 10) of the hydraulic control device (900 in FIG. 9) according to the fourth embodiment of the present invention, and thus additional descriptions of the respective operations will be omitted below.

Here, the hydraulic control method 1200 of the hydraulic control device 1100 according to the fifth embodiment of the present invention further includes third identification S1212b.

In one example, the hydraulic control method 1200 of the hydraulic control device 1100 thereof according to the fifth embodiment of the present invention may further include third identification S1212b after the pressure creation-correction S1210b.

In another example, although not shown, a hydraulic control method (not shown) of the hydraulic control device 1100 according to the fifth embodiment of the present invention may further include third identification (not shown) synchronized with pressure creation-correction (not shown).

More specifically, when the pressure creation-correction unit 1118 provides the hydraulic valve 1102 with the corrected magnitude of created pressure, in the third identification S1212b, the third identifying unit 1111 assists the driver in identifying a current created pressure correcting situation under control of the controller 1106.

In addition, the hydraulic control method 1200 of the hydraulic control device 1100 according to the fifth embodiment of the present invention may further include second identification S1212a.

In one example, the hydraulic control method 1200 of the hydraulic control device 1100 according to the fifth embodiment of the present invention may further include second identification S1212a after the brake pressure correction S1210a.

In another example, although not shown, a hydraulic control method (not shown) of the hydraulic control device 1100 according to the fifth embodiment of the present invention may further include brake pressure correction (not shown) synchronized with second identification (not shown).

More specifically, when the brake pressure correction unit 1110 provides the left wheel 60 and the right wheel 70 with the corrected brake pressure, in the second identification S1212a, the second identifying unit 1119 assists the driver in identifying a current brake pressure correcting situation under control of the controller 1106.

As described above, the hydraulic control device 1100 and the hydraulic control method 1200 according to the fifth embodiment of the present invention include the hydraulic valve 1102, the hydraulic-valve sensing unit 1104, the pressure creating/providing unit 1114, the pressure creating-state sensing unit 1116, the controller 1106, the first judging unit 1108, the first identifying unit 1109, the brake pressure correction unit 1110, the pressure creation-correction unit 1118, the second identifying unit 1119, and the third identifying unit 1111, and implement the hydraulic-pressure provision S1202, the sensing S1204, the first judgment S1206, the first identification S1208, the brake pressure correction S1210a, the second identification S1212a, the pressure creation-correction S1210b, and the third identification S1212b.

Accordingly, when the magnitude of current brake pressure deviates from the target brake pressure range, the hydraulic control device 1100 and the hydraulic control method 1200 thereof according to the fifth embodiment of the present invention may enable identification of a situation in which the magnitude of current brake pressure deviates from the target brake pressure range.

In this way, the hydraulic control device 1100 and the hydraulic control method 1200 thereof according to the fifth embodiment of the present invention may assist the driver in recognizing the situation in which the magnitude of current brake pressure deviates from the target brake pressure range, which may induce the driver to carefully drive and to carefully step on the brake pedal.

In addition, when the magnitude of currently created pressure deviates from the target pressure creation range, the hydraulic control device 1100 and the hydraulic control method 1200 thereof according to the fifth embodiment of the present invention may enable identification of a situation in which the magnitude of currently created pressure deviates from the target pressure creation range.

In this way, the hydraulic control device 1100 and the hydraulic control method 1200 thereof according to the fifth embodiment of the present invention may assist the driver in recognizing the situation in which the magnitude of currently created pressure deviates from the target pressure creation range, which may induce the driver to carefully drive and to carefully step on the brake pedal.

In addition, when the magnitude of current brake pressure deviates from the target brake pressure range, the hydraulic control device 1100 and the hydraulic control method 1200 thereof according to the fifth embodiment of the present invention may correct current brake pressure into hydraulic-pressure conforming to the target brake pressure range, and provide the left wheel 60 and the right wheel 70 with the corrected brake pressure.

In this way, the hydraulic control device 1100 and the hydraulic control method 1200 thereof according to the fifth embodiment of the present invention may provide the left wheel 60 and the right wheel 70 with the corrected brake pressure when the driver steps on the brake pedal, thereby efficiently enhancing brake force and enabling braking by an improved brake distance.

In addition, when the magnitude of currently created pressure deviates from the target pressure creation range, the hydraulic control device 1100 and the hydraulic control method 1200 thereof according to the fifth embodiment of the present invention may correct current brake pressure into a given level of pressure conforming to the target brake pressure range, and provide the hydraulic valve 102 with the corrected magnitude of created pressure.

In this way, the hydraulic control device 1100 and the hydraulic control method 1200 thereof according to the fifth embodiment of the present invention may rapidly provide the left wheel 60 and the right wheel 70 with the corrected brake pressure when the driver steps on the brake pedal, thereby efficiently enhancing brake force and enabling rapid braking by an improved brake distance.

In addition, when the magnitude of current brake pressure deviates from the target brake pressure range, the hydraulic control device 1100 and the hydraulic control method 1200 thereof according to the fifth embodiment of the present invention may enable identification of a current brake pressure correcting situation when correcting brake pressure into hydraulic pressure conforming to the target brake pressure range and providing the left wheel 60 and the right wheel 70 with the corrected brake pressure.

In this way, the hydraulic control device 1100 and the hydraulic control method 1200 thereof according to the fifth embodiment of the present invention may assist the driver in recognizing a current brake pressure correcting situation, which may induce the driver to carefully drive and to carefully step on the brake pedal.

Moreover, when the magnitude of currently created pressure deviates from the target pressure creation range, the hydraulic control device 1100 and the hydraulic control method 1200 thereof according to the fifth embodiment of the present invention may enable identification of a current created pressure correcting situation when correcting created pressure into a given level of pressure conforming to the target pressure creation range and providing the hydraulic valve 102 with the corrected magnitude of created pressure.

In this way, the hydraulic control device 1100 and the hydraulic control method 1200 thereof according to the fifth embodiment of the present invention may assist the driver in recognizing a current created pressure correcting situation, which may induce the driver to carefully drive and to carefully step on the brake pedal.

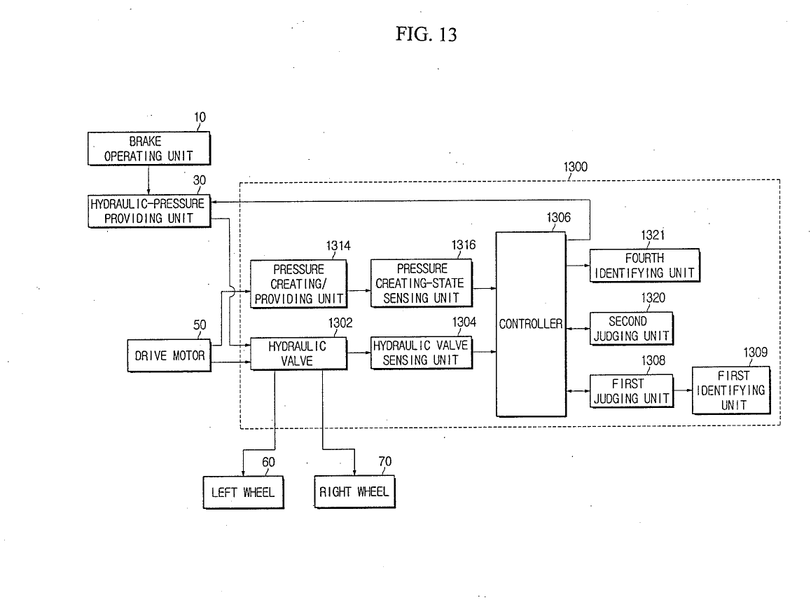

FIG. 13 is a block diagram showing an exemplary hydraulic control device according to a sixth embodiment of the present invention.

Referring to FIG. 13, the hydraulic control device, designated by reference numeral 1300, according to the sixth embodiment of the present invention includes a hydraulic valve 1302, a hydraulic-valve sensing unit 1304, a pressure creating/providing unit 1314, a pressure creating-state sensing unit 1316, a controller 1306, a first judging unit 1308, and a first identifying unit 1309, in the same manner as the hydraulic control device (100 in FIG. 2) according to the first embodiment.

Functions of and organic connection relationships between the hydraulic valve 1302, the hydraulic-valve sensing unit 1304, the pressure creating/providing unit 1314, the pressure creating-state sensing unit 1316, the controller 1306, the first judging unit 1308, and the first identifying unit 1309 of the hydraulic control device 1300 according to the sixth embodiment of the present invention are equal to functions of and organic connection relationships between the hydraulic valve (102 in FIG. 2), the hydraulic-valve sensing unit (104 in FIG. 2), the pressure creating/providing unit (114 in FIG. 2), the pressure creating-state sensing unit (116 in FIG. 2), the controller (106 in FIG. 2), the first judging unit (108 in FIG. 2), and the first identifying unit (109 in FIG. 2) of the hydraulic control device (100 in FIG. 2) according to the first embodiment of the present invention, and thus additional descriptions of the respective components will be omitted below.

Here, the hydraulic control device 1300 according to the sixth embodiment of the present invention further includes a second judging unit 1320 and a fourth identifying unit 1321.

More specifically, the second judging unit 1320 judges, under control of the controller 1306, whether the magnitude of current brake pressure per currently created pressure, sensed by the hydraulic-valve sensing unit 1304 and the pressure creating-state sensing unit 1316, is in a third state deviating from a preset target brake pressure range per target pressure creation range.

Here, although not shown, the controller 1306 and the second judging unit 1320 may include a conventional ECU (not shown) that is a main computer for a vehicle to control and judge all operations, or a conventional MCU (not shown) in which a processor, a memory, and input/output devices are incorporated in a single chip to control and judge all operations, without being limited thereto, and various other control and judging devices to control and judge all operations of a vehicle may be employed.

In this case, the controller 1306 and the second judging unit 1320 may be an integrated ECU or MCU, or may be separate ECUs or MCUs.

When the second judging unit 1320 judges that the magnitude of current brake pressure per currently created pressure is in the third state deviating from the target brake pressure range per target pressure creation range, the fourth identifying unit 1321 assists the driver in identifying a situation in which the magnitude of current brake pressure per currently created pressure deviates from the target brake pressure range per target pressure creation range.

In this case, although not shown, the fourth identifying unit 1321 may include at least one of a speaker (not shown) and a light emitting member (not shown), which assist the driver in identifying vehicle information or state, and an HMI module (not shown) and an HUD module (not shown), which assist the driver in recognizing vehicle information or state via interaction of a user and a machine. Through at least one of audio output by the speaker (not shown), light emission by the light emitting member (not shown), HMI message display by the HMI module (not shown), and HUD message display by the HUD module (not shown), identification of a situation in which the magnitude of current brake pressure per currently created pressure deviates from the target brake pressure range per target pressure creation range may be possible.

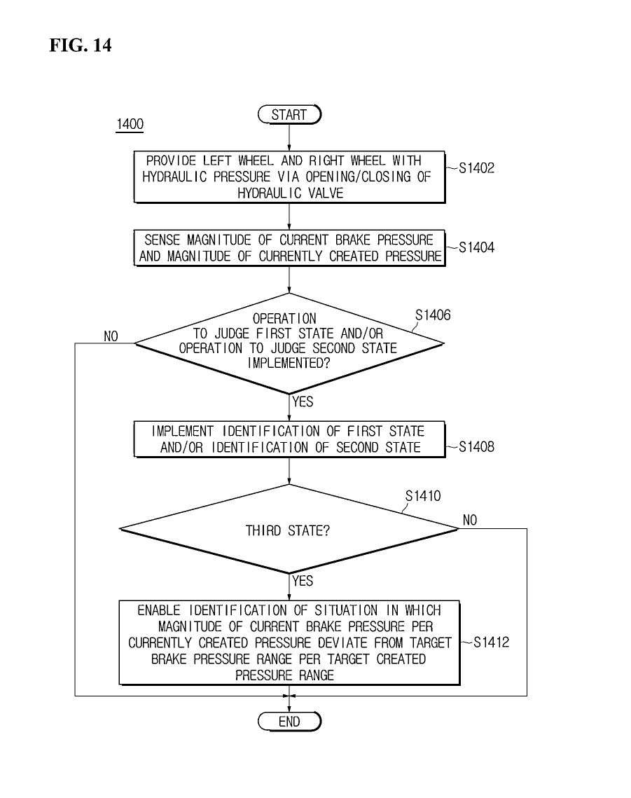

Now, a hydraulic control method for control of hydraulic-pressure using the hydraulic control device 1300 according to the sixth embodiment of the present invention will be described with reference to FIG. 14.

FIG. 14 is a flowchart showing a hydraulic control method of the hydraulic control device according to the sixth embodiment of the present invention.

Referring to FIG. 14, the hydraulic control method, designated by reference numeral 1400, of the hydraulic control device (1300 in FIG. 13) according to the sixth embodiment of the present invention includes hydraulic-pressure provision S1402, sensing S1404, first judgment S1406, and first identification S1408, in the same manner as the hydraulic control method (400 in FIG. 4) of the hydraulic control device (100 in FIG. 2) according to the first embodiment.

Functions of and organic connection relationships between the hydraulic-pressure provision S1402, the sensing S1404, the first judgment S1406, and the first identification S1408 of the hydraulic control method 1400 of the hydraulic control device (1300 in FIG. 13) according to the sixth embodiment of the present invention are equal to functions of and organic connection relationships between the hydraulic-pressure provision (S402 in FIG. 4), the sensing (S404 in FIG. 4), the first judgment (S406 in FIG. 4), and the first identification (S408 in FIG. 4) of the hydraulic control method (400 in FIG. 4) of the hydraulic control device (100 in FIG. 2) according to the first embodiment of the present invention, and thus additional descriptions of the respective operations will be omitted below.

Here, the hydraulic control method 1400 of the hydraulic control device 1300 according to the sixth embodiment of the present invention further includes second judgment S1410 and fourth identification S1412.

In one example, the hydraulic control method 1400 of the hydraulic control device 1300 thereof according to the sixth embodiment of the present invention may further include second judgment S1410 and fourth identification S1412 after the first identification S1408.

In another example, although not shown, a hydraulic control method (not shown) of the hydraulic control device (1300 in FIG. 13) according to the sixth embodiment of the present invention may further include second judgment (not shown) synchronized with first identification (not shown), and may further include fourth identification (not shown) after the second judgment (not shown).

More specifically, in the second judgment S1410, the second judging unit 1320 judges, under control of the controller 1306, whether the magnitude of current brake pressure per currently created pressure, sensed by the hydraulic-valve sensing unit 1304 and the pressure creating-state sensing unit 1316, is in a third state deviating from a preset target brake pressure range per target pressure creation range.

Thereafter, in the fourth identification S1412, when the second judging unit 1320 judges that the magnitude of current brake pressure per currently created pressure is in the third state deviating from the preset target brake pressure range per target pressure creation range, the fourth identifying unit 1321 assists the driver in identifying a situation in which the magnitude of current brake pressure per currently created pressure deviates from the target brake pressure range per target pressure creation range.

The hydraulic control device 1300 and the hydraulic control method 1400 thereof according to the sixth embodiment of the present invention include the hydraulic valve 1302, the hydraulic-valve sensing unit 1304, the pressure creating/providing unit 1314, the pressure creating-state sensing unit 1316, the controller 1306, the first judging unit 1308, the first identifying unit 1309, the second judging unit 1320, and the fourth identifying unit 1321, and implement the hydraulic-pressure provision S1402, the sensing S1404, the first judgment S1406, the first identification S1408, the second judgment S1410, and the fourth identification S1412.

Accordingly, when the magnitude of current brake pressure deviates from the target brake pressure range, the hydraulic control device 1300 and the hydraulic control method 1400 thereof according to the sixth embodiment of the present invention may enable identification of a situation in which the magnitude of current brake pressure deviates from the target brake pressure range.

In this way, the hydraulic control device 1300 and the hydraulic control method 1400 thereof according to the sixth embodiment of the present invention may assist the driver in recognizing the situation in which the magnitude of current brake pressure deviates from the target brake pressure range, which may induce the driver to carefully drive and to carefully step on a brake pedal.

In addition, when the magnitude of currently created pressure deviates from the target pressure creation range, the hydraulic control device 1300 and the hydraulic control method 1400 thereof according to the sixth embodiment of the present invention may enable identification of a situation in which the magnitude of currently created pressure deviates from the target pressure creation range.

In this way, the hydraulic control device 1300 and the hydraulic control method 1400 thereof according to the sixth embodiment of the present invention may assist the driver in recognizing the situation in which the magnitude of currently created pressure deviates from the target pressure creation range, which may induce the driver to carefully drive and to carefully step on a brake pedal.

Moreover, when the magnitude of current brake pressure per currently created pressure deviates from the target brake pressure range per target pressure creation range, the hydraulic control device 1300 and the hydraulic control method 1400 thereof according to the sixth embodiment of the present invention may enable identification of a situation in which the magnitude of current brake pressure per currently created pressure deviates from the target brake pressure range per target pressure creation range.

In this way, the hydraulic control device 1300 and the hydraulic control method 1400 thereof according to the sixth embodiment of the present invention may assist the driver in recognizing a situation in which the magnitude of current brake pressure per currently created pressure deviates from the target brake pressure range per target pressure creation range, which may induce the driver to carefully drive and to carefully step on a brake pedal.

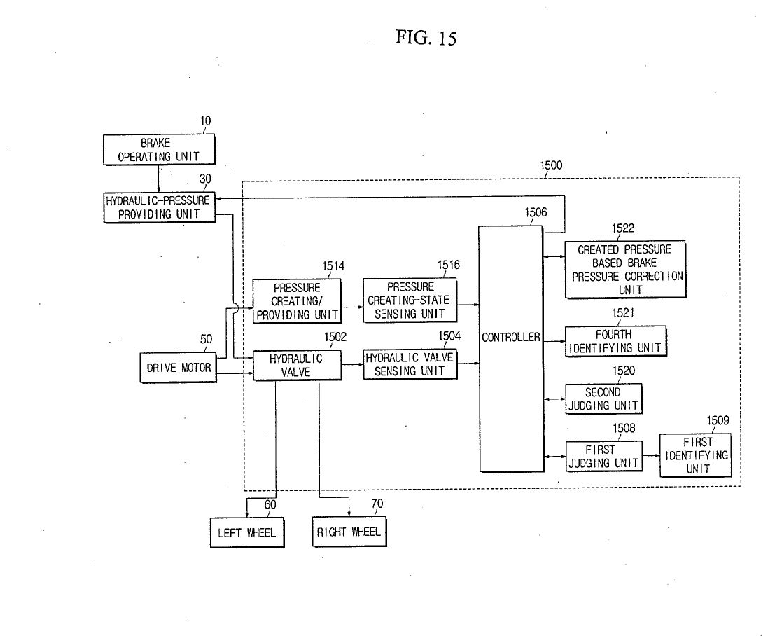

FIG. 15 is a block diagram showing an exemplary hydraulic control device according to a seventh embodiment of the present invention.

Referring to FIG. 15, the hydraulic control device, designated by reference numeral 1500, according to the seventh embodiment of the present invention includes a hydraulic valve 1502, a hydraulic-valve sensing unit 1504, a pressure creating/providing unit 1514, a pressure creating-state sensing unit 1516, a controller 1506, a first judging unit 1508, a first identifying unit 1509, a second judging unit 1520, and a fourth identifying unit 1521, in the same manner as the hydraulic control device (1300 in FIG. 13) according to the sixth embodiment.

Functions of and organic connection relationships between the hydraulic valve 1502, the hydraulic-valve sensing unit 1504, the pressure creating/providing unit 1514, the pressure creating-state sensing unit 1516, the controller 1506, the first judging unit 1508, the first identifying unit 1509, the second judging unit 1520, and the fourth identifying unit 1521 of the hydraulic control device 1500 according to the seventh embodiment of the present invention are equal to functions of and organic connection relationships between the hydraulic valve (1302 in FIG. 13), the hydraulic-valve sensing unit (1304 in FIG. 13), the pressure creating/providing unit (1314 in FIG. 13), the pressure creating-state sensing unit (1316 in FIG. 13), the controller (1306 in FIG. 13), the first judging unit (1308 in FIG. 13), the first identifying unit (1309 in FIG. 13), the second judging unit (1320 in FIG. 13) and fourth identifying unit (1321 in FIG. 13) of the hydraulic control device (1300 in FIG. 13) according to the sixth embodiment of the present invention, and thus additional descriptions of the respective components will be omitted below.

Here, the hydraulic control device 1500 according to the seventh embodiment of the present invention further includes a created pressure based brake pressure correction unit 1522.

More specifically, when the second judging unit 1520 judges that the magnitude of current brake pressure per currently created pressure is in a third state deviating from a target brake pressure range per target pressure creation range, the created pressure based brake pressure correction unit 1522 opens the hydraulic valve 1502 to correct brake pressure, i.e. hydraulic pressure, fed from the hydraulic-pressure providing unit 30 via braking operation of the brake operating unit 10 under control of the controller 1506, into hydraulic pressure conforming to the target brake pressure range per target pressure creation range, and to provide the left wheel 60 and the right wheel 70 with the corrected brake pressure per created pressure.

Here, although not shown, the controller 1506, the first judging unit 1508, the second judging unit 1520, and the created pressure based brake pressure correction unit 1522 may include a conventional ECU (not shown) that is a main computer for a vehicle to control and judge all operations and to correct brake pressure per created pressure, or a conventional MCU (not shown) in which a processor, a memory, and input/output devices are incorporated in a single chip to control and judge all operations and to correct brake pressure per created pressure, without being limited thereto, and various other devices to control and judge all operations of a vehicle and to correct brake pressure per created pressure may be employed.

In this case, the controller 1506, the first judging unit 1508, the second judging unit 1520, and the created pressure based brake pressure correction unit 1522 may be an integrated ECU or MCU, or may be separate ECUs or MCUs.

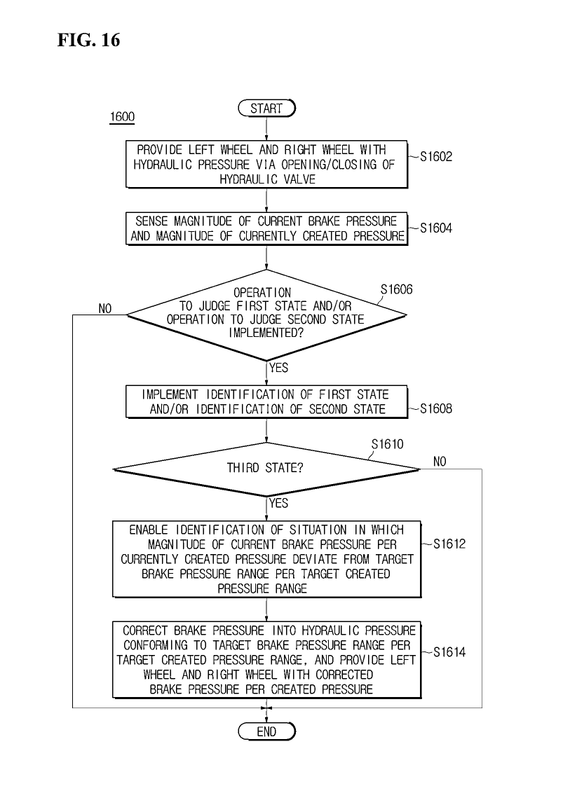

Now, a hydraulic control method for control of hydraulic-pressure using the hydraulic control device 1500 according to the seventh embodiment of the present invention will be described with reference to FIG. 16.

FIG. 16 is a flowchart showing a hydraulic control method of the hydraulic control device according to the seventh embodiment of the present invention.

Referring to FIG. 16, the hydraulic control method, designated by reference numeral 1600, of the hydraulic control device (1500 in FIG. 15) according to the seventh embodiment of the present invention includes hydraulic-pressure provision S1602, sensing S1604, first judgment S1606, first identification S1608, second judgment S1610, and fourth identification S1612, in the same manner as the hydraulic control method (1400 in FIG. 14) of the hydraulic control device (1300 in FIG. 13) according to the sixth embodiment.

Functions of and organic connection relationships between the hydraulic-pressure provision S1602, the sensing S1604, the first judgment S1606, the first identification S1608, the second judgment S1610, and the fourth identification S1612 of the hydraulic control method 1600 of the hydraulic control device (1500 in FIG. 15) according to the seventh embodiment of the present invention are equal to functions of and organic connection relationships between the hydraulic-pressure provision (S1402 in FIG. 14), the sensing (S1404 in FIG. 14), the first judgment (S1406 in FIG. 14), the first identification (S1408 in FIG. 14), the second judgment (S1410 in FIG. 14), and the fourth identification (S1412 in FIG. 14) of the hydraulic control method (1400 in FIG. 14) of the hydraulic control device (1300 in FIG. 13) according to the sixth embodiment of the present invention, and thus additional descriptions of the respective operations will be omitted below.

Here, the hydraulic control method 1600 of the hydraulic control device 1500 according to the seventh embodiment of the present invention further includes created pressure based brake pressure correction S1614.

In one example, the hydraulic control method 1600 of the hydraulic control device 1500 according to the seventh embodiment of the present invention may further include created pressure based brake pressure correction S1614 after the fourth identification S1612.

In another example, although not shown, a hydraulic control method (not shown) of the hydraulic control device (1500 in FIG. 15) according to the seventh embodiment of the present invention may further include created pressure based brake pressure correction (not shown) synchronized with fourth identification (not shown).

More specifically, when the second judging unit 1520 judges that the magnitude of current brake pressure per currently created pressure is in a third state deviating from a target brake pressure range per target pressure creation range, in the created pressure based brake pressure correction S1614, the created pressure based brake pressure correction unit 1522 opens the hydraulic valve 1502 to correct brake pressure, i.e. hydraulic pressure, fed from the hydraulic-pressure providing unit 30 via braking operation of the brake operating unit 10 under control of the controller 1506, into hydraulic pressure conforming to the target brake pressure range per target pressure creation range, and to provide the left wheel 60 and the right wheel 70 with the corrected brake pressure per created pressure.

As described above, the hydraulic control device 1500 and the hydraulic control method 1600 according to the seventh embodiment of the present invention include the hydraulic valve 1502, the hydraulic-valve sensing unit 1504, the pressure creating/providing unit 1514, the pressure creating-state sensing unit 1516, the controller 1506, the first judging unit 1508, the first identifying unit 1509, the second judging unit 1520, the fourth identifying unit 1521, and created pressure based brake pressure correction unit 1522, and implement the hydraulic-pressure provision S1602, the sensing S1604, the first judgment S1606, the first identification S1608, the second judgment S1610, the fourth identification S1612, and the created pressure based brake pressure correction S1614.

Accordingly, when the magnitude of current brake pressure deviates from the target brake pressure range, the hydraulic control device 1500 and the hydraulic control method 1600 thereof according to the seventh embodiment of the present invention may provide identification of a situation in which the magnitude of current brake pressure deviates from the target brake pressure range.

In this way, the hydraulic control device 1500 and the hydraulic control method 1600 thereof according to the seventh embodiment of the present invention may assist the driver in recognizing the situation in which the magnitude of current brake pressure deviates from the target brake pressure range, which may induce the driver to carefully drive and to carefully step on a brake pedal.

In addition, when the magnitude of currently created pressure deviates from the target pressure creation range, the hydraulic control device 1500 and the hydraulic control method 1600 thereof according to the seventh embodiment of the present invention may enable identification of a situation in which the magnitude of currently created pressure deviates from the target pressure creation range.

In this way, the hydraulic control device 1500 and the hydraulic control method 1600 thereof according to the seventh embodiment of the present invention may assist the driver in recognizing the situation in which the magnitude of currently created pressure deviates from the target pressure creation range, which may induce the driver to carefully drive and to carefully step on a brake pedal.

In addition, when the magnitude of current brake pressure per currently created pressure deviates from the target brake pressure range per target pressure creation range, the hydraulic control device 1500 and the hydraulic control method 1600 thereof according to the seventh embodiment of the present invention may identify a situation in which the magnitude of current brake pressure per currently created pressure deviates from the target brake pressure range per target pressure creation range.

In this way, the hydraulic control device 1500 and the hydraulic control method 1600 according to the seventh embodiment of the present invention may assist the driver in recognizing a situation in which the magnitude of current brake pressure per currently created pressure deviates from the target brake pressure range per target pressure creation range, which may induce the driver to carefully drive and to carefully step on a brake pedal.

Moreover, when the magnitude of current brake pressure per currently created pressure deviates from the target brake pressure range per target pressure creation range, the hydraulic control device 1500 and the hydraulic control method 1600 thereof according to the seventh embodiment of the present invention may correct brake pressure into hydraulic pressure conforming to the target brake pressure range per target pressure creation range, and provide the left wheel 60 and the right wheel 70 with the corrected brake pressure per created pressure.

In this way, the hydraulic control device 1500 and the hydraulic control method 1600 thereof according to the seventh embodiment of the present invention may provide the left wheel 60 and the right wheel 70 with the corrected brake pressure when the driver steps on the brake pedal, thereby efficiently enhancing brake force and enabling braking by an improved brake distance.

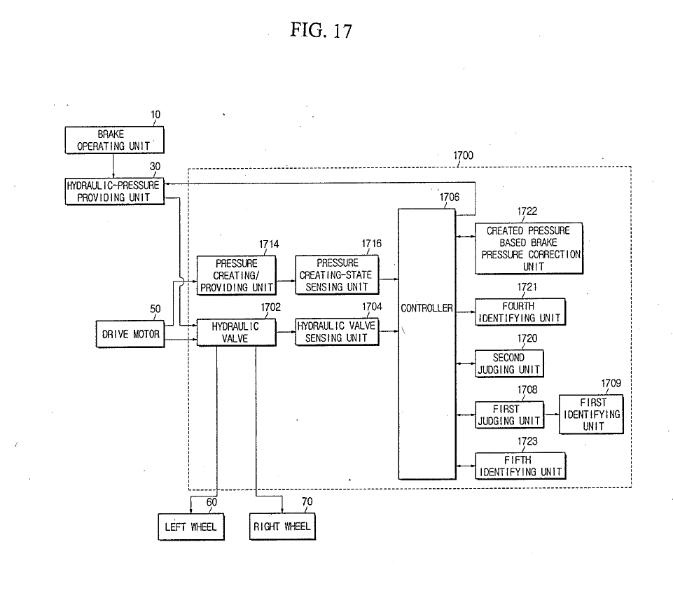

FIG. 17 is a block diagram showing an exemplary hydraulic control device according to an eighth embodiment of the present invention.

Referring to FIG. 17, the hydraulic control device, designated by reference numeral 1700, according to the eighth embodiment of the present invention includes a hydraulic valve 1702, a hydraulic-valve sensing unit 1704, a pressure creating/providing unit 1714, a pressure creating-state sensing unit 1716, a controller 1706, a first judging unit 1708, a first identifying unit 1709, a second judging unit 1720, a fourth identifying unit 1721, and a created pressure based brake pressure correction unit 1722, in the same manner as the hydraulic control device (1500 in FIG. 15) according to the seventh embodiment.

Functions of and organic connection relationships between the hydraulic valve 1702, hydraulic-valve sensing unit 1704, pressure creating/providing unit 1714, pressure creating-state sensing unit 1716, controller 1706, first judging unit 1708, first identifying unit 1709, second judging unit 1720, fourth identifying unit 1721, and created pressure based brake pressure correction unit 1722 of the hydraulic control device 1700 according to the eighth embodiment of the present invention are equal to functions of and organic connection relationships between the hydraulic valve (1502 in FIG. 15), the hydraulic-valve sensing unit (1504 in FIG. 15), the pressure creating/providing unit (1514 in FIG. 15), the pressure creating-state sensing unit (1516 in FIG. 15), the controller (1506 in FIG. 15), the first judging unit (1508 in FIG. 15), the first identifying unit (1509 in FIG. 15), the second judging unit (1520 in FIG. 15), the fourth identifying unit (1521 in FIG. 15), and the created pressure based brake pressure correction unit (1522 in FIG. 15) of the hydraulic control device (1500 in FIG. 15) according to the seventh embodiment of the present invention, and thus additional descriptions of the respective components will be omitted below.

Here, the hydraulic control device 1700 according to the eighth embodiment of the present invention further includes a fifth identifying unit 1723.

More specifically, when the created pressure based brake pressure correction unit 1722 provides the left wheel 60 and the right wheel 70 with the corrected brake pressure per created pressure, the fifth identifying unit 1723 assists the driver in identifying a situation in which brake pressure is corrected per currently created pressure under control of the controller 1706.

In this case, although not shown, the fifth identifying unit 1723 may include at least one of a speaker (not shown) and a light emitting member (not shown), which assist the driver in identifying vehicle information or state, and an HMI module (not shown) and an HUD module (not shown), which assist the driver in recognizing vehicle information or state via interaction of a user and a machine. Through at least one of audio output by the speaker (not shown), light emission by the light emitting member (not shown), HMI message display by the HMI module (not shown), and HUD message display by the HUD module (not shown), identification of a situation in which brake pressure is corrected per currently created pressure may be possible.

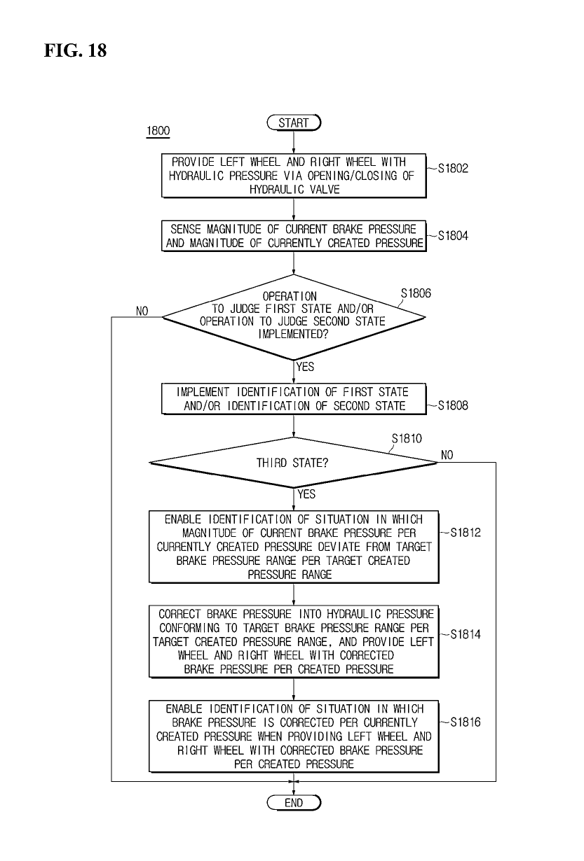

Now, a hydraulic control method for control of hydraulic-pressure using the hydraulic control device 1700 according to the eighth embodiment of the present invention will be described with reference to FIG. 18.

FIG. 18 is a flowchart showing a hydraulic control method of the hydraulic control device according to the eighth embodiment of the present invention.

Referring to FIG. 18, the hydraulic control method, designated by reference numeral 1800, of the hydraulic control device (1700 in FIG. 17) according to the eighth embodiment of the present invention includes hydraulic-pressure provision S1802, sensing S1804, first judgment S1806, first identification S1808, second judgment S1810, fourth identification S1812, and created pressure based brake pressure correction S1814, in the same manner as the hydraulic control method (1600 in FIG. 16) of the hydraulic control device (1500 in FIG. 15) according to the seventh embodiment.

Functions of and organic connection relationships between the hydraulic-pressure provision S1802, the sensing S1804, the first judgment S1806, the first identification S1808, the second judgment S1810, the fourth identification S1812, and the created pressure based brake pressure correction S1814 of the hydraulic control method 1800 of the hydraulic control device (1700 in FIG. 17) according to the eighth embodiment of the present invention are equal to functions of and organic connection relationships between the hydraulic-pressure provision (S1602 in FIG. 16), the sensing (S1604 in FIG. 16), the first judgment (S1606 in FIG. 16), the first identification (S1608 in FIG. 16), the second judgment (S1610 in FIG. 16), the fourth identification (S1612 in FIG. 16), and the created pressure based brake pressure correction (S1614 in FIG. 16) of the hydraulic control method (1600 in FIG. 16) of the hydraulic control device (1500 in FIG. 15) according to the seventh embodiment of the present invention, and thus additional descriptions of the respective operations will be omitted below.

Here, the hydraulic control method 1800 of the hydraulic control device 1700 according to the eighth embodiment of the present invention further includes fifth identification S1816.

In one example, the hydraulic control method 1800 of the hydraulic control device 1700 according to the eighth embodiment of the present invention may further include fifth identification S1816 after the created pressure based brake pressure correction S1814.

In another example, although not shown, a hydraulic control method (not shown) of the hydraulic control device (1700 in FIG. 17) according to the eighth embodiment of the present invention may further include fifth identification (not shown) synchronized with created pressure based brake pressure correction (not shown).

More specifically, when the created pressure based brake pressure correction unit 1722 provides the left wheel 60 and the right wheel 70 with the corrected brake pressure per created pressure, in the fifth identification S1816, the fifth identifying unit 1723 assists the driver in identifying a situation in which brake pressure is corrected per currently created pressure under control of the controller 1706.

As described above, the hydraulic control device 1700 and the hydraulic control method 1800 thereof according to the eighth embodiment of the present invention include the hydraulic valve 1702, the hydraulic-valve sensing unit 1704, the pressure creating/providing unit 1714, the pressure creating-state sensing unit 1716, the controller 1706, the first judging unit 1708, the first identifying unit 1709, the second judging unit 1720, the fourth identifying unit 1721, the created pressure based brake pressure correction unit 1722, and the fifth identifying unit 1723, and implement the hydraulic-pressure provision S1802, the sensing S1804, the first judgment S1806, the first identification S1808, the second judgment S1810, the fourth identification S1812, the created pressure based brake pressure correction S1814, and the fifth identification S1816.

Accordingly, when the magnitude of current brake pressure deviates from the target brake pressure range, the hydraulic control device 1700 and the hydraulic control method 1800 thereof according to the eighth embodiment of the present invention may enable identification of a situation in which the magnitude of current brake pressure deviates from the target brake pressure range.

In this way, the hydraulic control device 1700 and the hydraulic control method 1800 thereof according to the eighth embodiment of the present invention may assist the driver in recognizing the situation in which the magnitude of current brake pressure deviates from the target brake pressure range, which may induce the driver to carefully drive and to carefully step on the brake pedal.

In addition, when the magnitude of currently created pressure deviates from the target pressure creation range, the hydraulic control device 1700 and the hydraulic control method 1800 thereof according to the eighth embodiment of the present invention may enable identification of a situation in which the magnitude of currently created pressure deviates from the target pressure creation range.

In this way, the hydraulic control device 1700 and the hydraulic control method 1800 thereof according to the eighth embodiment of the present invention may assist the driver in recognizing the situation in which the magnitude of currently created pressure deviates from the target pressure creation range, which may induce the driver to carefully drive and to carefully step on a brake pedal.

In addition, when the magnitude of current brake pressure per currently created pressure deviates from the target brake pressure range per target pressure creation range, the hydraulic control device 1700 and the hydraulic control method 1800 thereof according to the eighth embodiment of the present invention may enable identification of a situation in which the magnitude of current brake pressure per currently created pressure deviates from the target brake pressure range per target pressure creation range.

In this way, the hydraulic control device 1700 and the hydraulic control method 1800 thereof according to the eighth embodiment of the present invention may assist the driver in recognizing a situation in which the magnitude of current brake pressure per currently created pressure deviates from the target brake pressure range per target pressure creation range, which may induce the driver to carefully drive and to carefully step on the brake pedal.

In addition, when the magnitude of current brake pressure per currently created pressure deviates from the target brake pressure range per target pressure creation range, the hydraulic control device 1700 and the hydraulic control method 1800 thereof according to the eighth embodiment of the present invention may correct brake pressure into hydraulic pressure conforming to the target brake pressure range per target pressure creation range, and provide the left wheel 60 and the right wheel 70 with the corrected brake pressure per created pressure.

In this way, the hydraulic control device 1700 and the hydraulic control method 1800 thereof according to the eighth embodiment of the present invention may provide the left wheel 60 and the right wheel 70 with the corrected brake pressure when the driver steps on the brake pedal, thereby efficiently enhancing brake force and enabling braking by an improved brake distance.

In addition, the magnitude of current brake pressure per currently created pressure deviates from the target brake pressure range per target pressure creation range, the hydraulic control device 1700 and the hydraulic control method 1800 thereof according to the eighth embodiment of the present invention may enable identification of a situation in which brake pressure per currently created pressure is corrected when correcting brake pressure into hydraulic pressure conforming to the target brake pressure range per target pressure creation range and providing the left wheel 60 and the right wheel 70 with the corrected brake pressure per created pressure.

In this way, the hydraulic control device 1700 and the hydraulic control method 1800 thereof according to the eighth embodiment of the present invention may assist the driver in recognizing a situation in which the magnitude of current brake pressure per currently created pressure deviates from the target brake pressure range per target pressure creation range, which may induce the driver to carefully drive and to carefully step on the brake pedal.

As is apparent from the above description, a hydraulic control device and a hydraulic control method thereof according to the embodiments of the present invention may achieve the following effects.

Firstly, it may be possible to induce a driver to carefully drive and to carefully step on a brake pedal.

Secondly, it may be possible to efficiently improve brake force to enable braking by an improved brake distance.

Although the embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A hydraulic control device comprising:
a hydraulic valve sensing unit to sense the magnitude of current brake pressure fed from a hydraulic valve;
a pressure creating-state sensing unit to sense the magnitude of currently created pressure fed via a pressure creating/providing unit, the pressure creating/providing unit creating a given level of pressure to provide the hydraulic valve with the created pressure;
a first judging unit to implement operation to judge whether the sensed magnitude of current brake pressure is in a first state deviating from a preset target brake pressure range, and/or operation to judge whether the sensed magnitude of currently created pressure is in a second state deviating from a preset target pressure creation range;
a first identifying unit to implement operation to enable identification of the first state upon judgment of the first state, and/or operation to enable identification of the second state upon judgment of the second state; and
a controller to receive the magnitude of current brake pressure and the magnitude of currently created pressure, and to transmit a judgment command to the first judging unit to allow the first judging unit to judge at least one of the first state and the second state.

2. The device according to claim 1, further comprising a brake pressure correction unit to open the hydraulic valve upon judgment of the first state, so as to correct brake hydraulic pressure, fed from a hydraulic-pressure providing unit via braking operation of a brake operating unit, into hydraulic pressure conforming to the target brake pressure range and to provide a left wheel and a right wheel with the corrected brake pressure.

3. The device according to claim 2, further comprising a second identifying unit to enable identification of a current brake pressure correcting situation when providing the left wheel and the right wheel with the corrected brake pressure.

4. The device according to claim 1, further comprising a pressure creation-correction unit to correct currently created pressure into a given level of pressure conforming to the target pressure creation range upon judgment of the second state and to provide the hydraulic valve with corrected magnitude of created pressure.

5. The device according to claim 4, further comprising a third identifying unit to enable identification of a current created pressure correcting situation when providing the hydraulic valve with the corrected magnitude of created pressure.

6. The device according to claim 1, further comprising:
a second judging unit to judge whether the magnitude of current brake pressure per currently created pressure, sensed by the hydraulic-valve sensing unit and the pressure creating-state sensing unit, is in a third state deviating from a preset target brake pressure range per target pressure creation range; and
a fourth identifying unit to enable identification of a situation in which the magnitude of current brake pressure per currently created pressure deviates from the preset target brake pressure range per target pressure creation range upon judgment of the third state.

7. The device according to claim 6, further comprising a created pressure based brake pressure correction unit to open the hydraulic valve upon judgment of the third state, so as to correct brake hydraulic pressure, fed from a hydraulic-pressure providing unit via braking operation of a brake operating unit, into hydraulic pressure conforming to the target brake pressure range per target pressure creation range and to provide the left wheel and the right wheel with the corrected brake pressure per created pressure.

8. The device according to claim 7, further comprising a fifth identifying unit to enable identification of a current created pressure based brake pressure correcting situation when providing the left wheel and the right wheel with the corrected brake pressure per created pressure.

9. A hydraulic control method comprising:
hydraulic-pressure provision to provide a left wheel and a right wheel with hydraulic pressure, fed from a hydraulic-pressure providing unit via braking operation of a brake operating unit, by selectively opening or closing a hydraulic valve in response to a drive signal of a drive motor;
sensing to sense the magnitude of current brake pressure fed from the hydraulic valve, and to sense the magnitude of currently created pressure fed via a pressure creating/providing unit, the pressure creating/providing unit creating a given level of pressure to provide the hydraulic valve with the created pressure;
first judgment to implement operation to judge whether the sensed magnitude of current brake pressure is in a first state deviating from a preset target brake pressure range, and/or operation to judge whether the sensed magnitude of currently created pressure is in a second state deviating from a preset target pressure creation range; and
first identification to implement operation to enable identification of the first state upon judgment of the first state, and/or operation to enable identification of the second state upon judgment of the second state.

10. The method according to claim 9, further comprising brake pressure correction to open the hydraulic valve upon judgment of the first state, so as to correct brake hydraulic pressure into hydraulic pressure conforming to the target brake pressure range and to provide the left wheel and the right wheel with the corrected brake pressure.

11. The method according to claim 10, further comprising second identification to enable identification of a current brake pressure correcting situation when providing the left wheel and the right wheel with the corrected brake pressure.

12. The method according to claim 9, further comprising pressure creation-correction to correct currently created pressure into a given level of pressure conforming to the target pressure creation range upon judgment of the second state and to provide the hydraulic valve with the corrected magnitude of created pressure.

13. The method according to claim 12, further comprising third identification to enable identification of a current created pressure correcting situation when providing the hydraulic valve with the corrected magnitude of created pressure.

14. The method according to claim 9, further comprising:
second judgment to judge whether the magnitude of current brake pressure per currently created pressure, sensed by the hydraulic-valve sensing unit and the pressure creating-state sensing unit, is in a third state deviating from a preset target brake pressure range per target pressure creation range; and
fourth identification to enable identification of a situation in which the magnitude of current brake pressure per currently created pressure deviates from the preset target brake pressure range per target pressure creation range upon judgment of the third state.

15. The method according to claim 14, further comprising created pressure based brake pressure correction to open the hydraulic valve upon judgment of the third state, so as to correct brake hydraulic pressure, fed from the hydraulic-pressure providing unit via braking operation of the brake operating unit, into hydraulic pressure conforming to the target brake pressure range per target pressure creation range and to provide the left wheel and the right wheel with the corrected brake pressure per created pressure.

16. The method according to claim 15, further comprising fifth identification to enable identification of a current created pressure based brake pressure correcting situation when providing the left wheel and the right wheel with the corrected brake pressure per created pressure.
